(19) United States
(12) Patent Application Publication
(10) Pub. No.: US 2014/0166159 A1
(43) Pub. Date: Jun. 19, 2014

(54) LA(FE,SI)13-BASED MAGNETIC REFRIGERATION MATERIAL PREPARED FROM INDUSTRIAL-PURE MISCHMETAL AS THE RAW MATERIAL AND PREPARATION AND USE THEREOF

(71) Applicants: Ling Chen, Beijing (CN); Fengxia Hu, Beijing (CN); Jing Wang, Beijing (CN); Lifu Bao, Beijing (CN); Yingying Zhao, Beijing (CN); Baogen Shen, Beijing (CN); Jirong Sun, Beijing (CN); Huayang Gong, Hubei (CN)

(72) Inventors: Ling Chen, Beijing (CN); Fengxia Hu, Beijing (CN); Jing Wang, Beijing (CN); Lifu Bao, Beijing (CN); Yingying Zhao, Beijing (CN); Baogen Shen, Beijing (CN); Jirong Sun, Beijing (CN); Huayang Gong, Hubei (CN)

(73) Assignees: Hubei Quanyang Magnetic Materials Manufacturing Co., Ltd; Institute of Physics, Chinese Academy of Sciences

(21) Appl. No.: 14/232,084

(22) PCT Filed: Jul. 13, 2012
(86) PCT No.: PCT/CN2012/078609

§ 371 Date: Mar. 5, 2014

(30) Foreign Application Priority Data
Jul. 14, 2011 (CN) 201110197489.2
Oct. 12, 2011 (CN) 201110308146.9
Jul. 11, 2012 (CN) 201210239559.0
Jul. 11, 2012 (CN) 201210240443.9

(51) Int. Cl. H01F 1/01

(52) U.S. Cl. CPC H01F 1/015
USPC 148/122; 148/307

(57) ABSTRACT

The invention provides a La(Fe,Si)₁₃-based magnetic refrigeration material prepared from industrial-pure mischmetal as the raw material, wherein the industrial-pure mischmetal is impurity-containing and naturally proportionated La—Ce—Pr—Nd mischmetal or LaCe alloy which, as the intermediate product during rare earth extraction, is extracted from light rare earth ore. The invention further provides the preparation method and use of the material, wherein the preparation method comprises the steps of smelting and annealing industrial-pure mischmetal as the raw material to prepare the La(Fe,Si)₁₃-based magnetic refrigeration material. The presence of impurities in the industrial-pure mischmetal has no impact on the formation of the 1:13 phase, the presence of the first-order phase-transition property and metamagnetic behavior, and thus maintains the giant magnetocaloric effect of the magnetic refrigeration material. The preparation of La(Fe,Si)₁₃-based magnetic refrigeration material from industrial-pure mischmetal reduces the dependency on high-purity elementary rare earth raw material; lowers the cost for manufacturing the material; and thus plays an important role in development of the magnetic refrigeration application of materials.

### TECHNICAL FIELD

The present invention relates to a magnetic refrigeration material, particularly a La(Fe,Si)₁₃-based magnetic refrigeration material which has a significant magnetocaloric effect and is prepared from industrial-pure mischmetal as the raw material, and the preparation method and use thereof.

### BACKGROUND ART

Rare earth metal can be used widely. For instance, preparation of permanent magnet and novel magnetic refrigeration material relies on rare earth. The total amount of 17 rare earth elements accounts for 0.0153 wt % of earth crust, wherein cerium (Ce) has the highest content, accounting for 0.0046%. The total amount of 4 light rare earth elements, i.e. lanthanum (La), cerium (Ce), praseodymium (Pr) and neodymium (Nd) accounts for about 97% of all rare earth elements. Till now, about 250 types of rare-earth minerals have been found, however, only about 10 of them are worth mining. At present, mainly 4 types of minerals, including light rare earth mineral Bastnaesite and Urdite, are used to extract rare earth elements industrially. In China, the distribution of rare earth resource has a “heavy south and light north” feature. In other words, light rare earth is mostly stored in Inner Mongolia, north of China; whereas the heavy rare earth is mainly stored in the Nanling area, south of China. The largest light rare earth mine—Bastnaesite known in the world is located in Baiyuneboite, Inner Mongolia, China. Bastnaesite, together with Urdite, is extracted as the byproduct obtained in the process of mining iron. The total amount of rare earth is about 74.8% in Bastnaesite, wherein La is 22.6%, Ce is 53.3%, Pr is 5.5%, Nd is 16.2%, Sm is 1.1%, Eu is 0.3%, Gd is 0.6%, Tb is 0.1%, Dy is 0.2%, and Y is 0.1%. The total amount of rare earth is about 65.1% in Urdite, wherein La is 27.7%, Ce is 40.2%, Pr is 6.9%, Nd is 16.5%, Sm is 2.9%, Eu is 0.3%, Gd is 2.2%, Tb is 0.1%, Dy is 0.4%, Er is 0.1%, Yb is 0.7%, and Y is 2.1%. The percentages of these rare earth elements vary in different mines.

Over 15% of the total energy consumption is used for refrigeration. Now, the commonly used gas compression refrigeration technology has Carnot cycle efficiency up to only about 25%, and the gas refrigerant used in gas compression refrigeration damages atmospheric ozone layer and induces the greenhouse effect. Therefore, exploration of pollution-free and environment friendly refrigeration materials and development of novel refrigeration technologies with low energy consumption and high efficiency become very urgent in the whole world.

Magnetic refrigeration technology, as characterized by environment friendly, energy efficient, stable and reliable, has drawn great attention worldwide in recent years. Several types of giant magnetocaloric materials at room temperature and even high temperature zone were found successionally in US, China, Holland and Japan, which significantly increased the expectation for environment friendly magnetic refrigeration technology, e.g. Gd—Si—Ge, LaCaMnO₃, Ni—Mn—Ga, La (Fe, Si)₁₃-based compound, MnAs-based compound, etc. Common features of these novel giant magnetocaloric materials lie in that their magnetic entropy changes are all higher than that of the traditional magnetic refrigeration material Gd working around room temperature (R. T.), their phase-transition properties are of the first-order, most of them show strong magnetocrystalline coupling characteristics, and magnetic phase transition is accompanied with distinct crystalline structural transition. These novel materials also show different features. For example, Gd₅(Si₂Ge₂) alloy, found by Ames National Laboratory of United State in 1997, shows a giant magnetocaloric effect; its adiabatic temperature change ΔT is ˜30% higher than that of rare earth element Gd; and its magnetic entropy change is ˜100% higher than that of Gd. However, during the process of synthesizing this type of materials, the raw material Gd usually needs to be further purified. Normally, the commercially available Gd has a purity of 95-98 at. % (atomic ratio) and a price of USD 200/kg. However, the Gd₅(Si₂Ge₂) alloy synthesized from the commercially pure Gd shows no giant magnetocaloric effect. Nevertheless, the Gd₅(Si₂Ge₂) alloy synthesized from further purified raw material Gd with a purity of ≧99.8 at. % (atomic ratio) can exhibit a giant magnetocaloric effect. The price for Gd with a purity of ≧99.8 at. % is USD 4000/kg. In this case, the material cost is dramatically raised. It was also shown in the investigation that the presence of impurities (such as 0.43 at. % C, 0.43 at. % N, 1.83 at. % O) or addition of a little element C in the raw material both result in the disappearance of first-order phase transition feature of Gd₅(Si₂Ge₂), and the giant magnetocaloric effect disappears as well (J. Magn. Magn. Mater. 167, L 179 (1997); J. Appl. Phys. 85, 5365 (1999)). Among several other novel materials, the raw material for MnAs-based compound is toxic; NiMn-based Heusler alloy shows large hysteresis loss, and so on.

Among the several novel materials found in the past over ten years, La(Fe, Si)₁₃-based compound is commonly accepted worldwide and has the highest potential for magnetic refrigeration application in a high temperature zone or even at R.T. This alloy has many characters shown as follows: the cost of its raw material is low; phase-transition temperature, phase-transition property and hysteresis loss may vary upon component adjustment; its magnetic entropy change around R.T. is higher than that of Gd by one fold. In the institutes and laboratories of many countries, La(Fe,Si)₁₃-based magnetic refrigeration material has been used for prototype test. For instance, in 2006, La(Fe,Si)₁₃-based material was used for the first time in prototype test in Astronautics Technology Center, Astronautics Corporation of America. Preliminary result showed that its refrigeration capacity was superior to that of Gd. Furthermore, it was shown in the up-to-date prototype test result of this company in 2010 that La(Fe, Si)₁₃-based material has a refrigeration capacity higher than that of Gd by two folds at room temperature.

The investigation also showed that the phase-transition property of La(Fe, Si)₁₃-based compound varies with the adjustment of its components. For example, for the compound with low Si amount, its phase-transition property is normally of the first-order. Upon the increasing of Co content, Curie temperature increased, the first-order phase-transition property weakened and was gradually transitted to the second order; thus hysteresis loss was decreased gradually (no hysteresis loss for the second-order phase transition). However, due to the component change and exchange interaction, the range of magnetocaloric effect was reduced in turn. Addition of Mn can lower the Curie temperature by impacting the exchange interaction; the first-order phase-transition property weakened; hysteresis loss was decreased gradually; and the magnitude of magnetocaloric effect was reduced in turn. In contrast, it was found that replacement of La with small rare earth magnetic atoms (e.g. Ce, Pr, Nd) can enhance the first-order phase-transition property; and increase hysteresis loss and the magnitude of magnetocaloric effect. It was also found that introduction of interstitial atom (e.g C, H, B, etc.) with small atomic radii can increase Curie temperature; and enable magnetocaloric effect to occur in a higher temperature zone. For instance, when the content of the interstitial atom H in molecular formula LaFe_{11.5}Si_{1.5}H_{α} was increased from α=0 to α=1.8, the phase-transition temperature (peak temperature of magnetocaloric effect) was raised from 200K to 350K. It was expected that the first-order La(Fe,Si)₁₃-based compound showing a giant magnetocaloric effect can be used in magnetic refrigeration application in practice, so as to achieve ideal refrigerating effect.

Previous reports showed that during the preparation of La(Fe,Si)₁₃-based compound, commercially available elementary substances were used as the rare-earth raw materials. It is known that a great amount of rare earth elements La and Ce are contained in earth crust. Element Ce has the highest abundance, and then the next is Y, Nd, La, etc. The natural component of many rare earth minerals includes 20-30% of La, 40-60% of Ce and a mixture of other rare earth and non-rare earth elements. It is much easier for obtaining LaCe alloy with a ratio of about 1:2 than obtaining the elementary La and Ce respectively during extraction. Moreover, the price for the commercially available LaCe alloy is much lower than that of the commercially available elementary La and Ce. Therefore, it will be very important for the development of magnetic refrigeration application of materials if a giant magnetocaloric La(Fe,Si)₁₃-based compound having a NaZn₁₃ structure is prepared from the commercially available LaCe alloy as the raw material.

In addition, the four types of light rare earth elements La, Ce, Pr and Nd are usually stored in the same mineral in nature. For example, they account for about 98% of rare earth in Bastnaesite and up to about 91% of rare earth in Urdite mineral. Industrially, it is much easier for obtaining naturally proportionated La—Ce—Pr—Nd mischmetal than obtaining elementary La, Ce, Pr and Nd respectively from the minerals. Therefore industrial-pure La—Ce—Pr—Nd mischmetal has an absolute advantage in price compared with elementary rare earth. For instance, the prices for elementary rare earth metal La, Ce, Pr and Nd were about RMB 250,000/ton, about RMB 350,000/ton, about RMB 1,700,000/ton and about RMB 1,800,000/ton, respectively in 2011, and their average price was about RMB 1,025,000/ton; whereas the price for mischmetal La—Ce—Pr—Nd is about RMB 465,000/ton (the price is provided by Baotou Rare Earth Enterprises Federation http://www.reht.com/?thread-1271-1.html). It will be very prospective if La(Fe,Si)₁₃-based magnetic refrigeration material can be prepared from industrial-pure and naturally proportionated La—Ce—Pr—Nd mischmetal as the raw material, extracted from Bastnaesite, Urditeand or other minerals.

### Contents of Invention

As a result, one object of the invention is to provide a La(Fe,Si)₁₃-based magnetic refrigeration material prepared from industrial-pure mischmetal as the raw material. Another object of the invention is to provide the method for preparing the La(Fe,Si)₁₃-based magnetic refrigeration material described above. A further object of the invention is to provide a magnetic refrigerator comprising said La(Fe,Si)₁₃-based magnetic refrigeration material. Yet a further object of the invention is to provide use of said La(Fe,Si)₁₃-based magnetocaloric material in the preparation of refrigeration materials.

The objects of the invention are accomplished by the following technical solutions.

The invention provides a La(Fe,Si)₁₃-based magnetic refrigeration material prepared from industrial-pure mischmetal as the raw material, wherein the industrial-pure mischmetal is an impurity-containing and naturally proportionated La—Ce—Pr—Nd mischmetal or LaCe alloy which, as the intermediate product during rare earth extraction, is extracted from light rare earth ore, and the magnetic material has a NaZn₃-type structure, wherein

when the industrial-pure mischmetal is the impurity-containing La—Ce—Pr—Nd mischmetal extracted from light rare earth ore, the material is represented by the chemical formula: La₁₋ₓ(Ce,Pr,Nd)ₓ(Fe_{1-p-q}CoₚMn_{q})_{13-y}Si_{y}A_{α},

wherein, A is one or more selected from elements C, H and B,

x is in the range of 0<x≦0.5, preferably 0<x≦0.3,

p is in the range of 0≦p≦0.2,

q is in the range of 0≦q≦0.2,

y is in the range of 0.8<y≦1.8,

α is in the range of 0≦α≦3.0,

wherein, the relative molar ratio of the three elements Ce, Pr and Nd is same as the natural proportion of Ce, Pr and Nd in the La—Ce—Pr—Nd mischmetal, and the total number of moles of Ce, Pr and Nd is x; in the La—Ce—Pr—Nd mischmetal, the molar ratio of the four elements La, Ce, Pr and Nd is same as their natural proportion in the light rare earth ore; the La—Ce—Pr—Nd mischmetal has a purity of ≧95 wt. %, preferably a purity of ≧98 wt. %; the La—Ce—Pr—Nd mischmetal contains impurities comprising one or more of Sm, Fe, Si, Mg, Zn, W, Mo, Cu, Ni, Ti, Th, Y, Ca, Pb, Cr, C, H and O;

when the industrial-pure mischmetal is the impurity-containing and naturally proportionated LaCe alloy extracted from light rare earth ore during rare earth extraction, the material is represented by the chemical formula: La_{1-x-z}CeₓR_{z} (Fe_{1-p-q}CoₚMn_{q})_{13-y}Si_{y}A_{α},

wherein, R is one or both selected from elements Pr and Nd,

A is one or more selected from elements C, H and B,

x is in the range of 0<x≦0.5, preferably 0<x≦0.3,

z is in the range of 0≦z≦0.5, and x+z<1,

p is in the range of 0≦p≦0.2,

q is in the range of 0≦q≦0.2,

y is in the range of 0.8<y≦1.8,

α is in the range of 0≦α≦3.0,

wherein, the raw material LaCe alloy has a purity of ≧95 at. %; and the atomic ratio of La:Ce in the alloy is the same as their natural proportion in the light rare earth ore, preferably 1:1.6-1:2.3; the LaCe alloy contains impurities comprising one or more of Pr, Nd, Sm, Fe, Si, Mg, Zn, W, Mo, Cu, Ni, Ti, Th, Y, Ca, Pb, Cr, C, H and O.

The invention further provides a method for preparing said magnetic refrigeration material, and the method comprises the steps of:

1) preparing raw material according to the chemical formula,

where A includes element H, the raw material other than H is prepared according to the chemical formula, the raw material comprises industrial-pure mischmetal, i.e. an impurity-containing and naturally proportionated La—Ce—Pr—Nd mischmetal or LaCe alloy which, as an intermediate product during rare earth extraction, is extracted from light rare earth ore; wherein, as the industrial-pure mischmetal is the impurity-containing La—Ce—Pr—Nd mischmetal extracted from light rare earth ore, the material is represented by the chemical formula: La₁₋ₓ(Ce,Pr,Nd)ₓ(Fe_{1-p-q}CoₚMn_{q})_{13-y}Si_{y}A_{α}, and where the industrial-pure mischmetal is the impurity-containing LaCe alloy extracted from light rare earth ore during rare earth extraction, the material is represented by the chemical formula: La_{1-x-z}CeₓR_{z}(Fe_{1-p-q}CoₚMn_{q})_{13-y}Si_{y}A_{α};

2) preparing alloy ingots by arc melting technology, wherein the raw material prepared in step 1) is placed in an arc furnace, vacuumed, purged with argon gas, and smelted under the protection of argon gas, so as to obtain the alloy ingots;

3) vacuum annealing the alloy ingots obtained in step 2) and then quenching in liquid nitrogen or water, so as to obtain the magnetocaloric material La_{1-x-z}CeₓR_{z}(Fe_{1-p-q}CoₚMn_{q})_{13-y}Si_{y}A_{α} or La₁₋ₓ(Ce,Pr,Nd)ₓ (Fe_{1-p-q}CoₚMn_{q})_{13-y}Si_{y}A_{α} having a NaZn₁₃-type structure;

wherein, as A in the above chemical formula includes element H, the method further comprises the step of 4) pulverizing the material obtained from step 3) and then annealing the resultant powder in hydrogen gas.

The invention further provides a magnetic refrigerator which comprises a magnetic refrigeration material according to the invention or a magnetic refrigeration material prepared by a method according to the invention.

The invention further provides use of a magnetic refrigeration material according to the invention or a magnetic refrigeration material prepared by a method according to the invention in the manufacture of a refrigeration material.

### DESCRIPTION OF DRAWINGS

The invention is further illustrated with reference to the following figures, wherein:

FIG. 1 shows the XRD spectrum of samples La_{0.7}Ce_{0.3}Fe_{11.6}Si_{1.4}C_{y} (y=0.2, 0.3) prepared in Example 1, at room temperature;

FIG. 2 shows the thermomagnetic (M-T) curves of samples La_{0.7}Ce_{0.3}Fe_{11.6}Si_{1.4}C_{y} (y=0.2, 0.3) prepared in Example 1, in a magnetic field of 0.02 T;

FIG. 3 shows the magnetization curves (M-H curve) of samples La_{0.7}Ce_{0.3}Fe_{11.6}Si_{1.4}C_{y} (y=0.2, 0.3) prepared in Example 1, in the process of increasing the field, at different temperatures;

FIG. 4 indicates the dependency of the magnetic entropy change ΔS of samples La_{0.7}Ce_{0.3}Fe_{11.6}Si_{1.4}C_{y} (y=0.2, 0.3) prepared in Example 1 while magnetic field changes differently on temperature;

FIG. 5 shows the XRD spectrum of samples La_{0.7}Ce_{0.3}(Fe₁₋ₓCoₓ)_{11.6}Si_{1.4} (x=0.04, 0.06, 0.08) prepared in Example 2, at room temperature, wherein the peaks labeled with “*” represent unknown impurity phases;

FIG. 6 shows the thermomagnetic (M-T) curves of samples La_{0.7}Ce_{0.3} (Fe₁₋ₓCoₓ)_{11.6}Si_{1.4} (x=0.04, 0.06, 0.08) prepared in Example 2, in a magnetic field of 0.02 T;

FIG. 7 shows the magnetization curves (M-H curves) of samples La_{0.7}Ce_{0.3}(Fe₁₋ₓCoₓ)_{11.6}Si_{1.4} (x=0.04, 0.06, 0.08) prepared in Example 2, in the process of increasing the field at different temperatures and Arrott plot (FIG. 7d) generated from the M-H curves (FIGS. 7a, b, c);

FIG. 8 indicates the dependency of the magnetic entropy change ΔS of samples La_{0.7}Ce_{0.3}(Fe₁₋ₓCoₓ)_{11.6}Si_{1.4} (x=0.04, 0.06, 0.08) prepared in Example 2 while magnetic field changes differently on temperature;

FIG. 9 shows the XRD spectrum of samples La_{0.95-y}Ce_{0.05}Pr_{y}Fe_{11.5}Si_{1.5} (y=0.1, 0.5) prepared in Example 3, at room temperature, wherein the peaks labeled with “*” represent unknown impurity phases;

FIG. 10 shows the thermomagnetic (M-T) curves of samples La_{0.95-y}Ce_{0.05}Pr_{y}Fe_{11.5}Si_{1.5} (y=0.1, 0.5) prepared in Example 3, in a magnetic field of 0.02 T;

FIG. 11 indicates the dependency of the magnetic entropy change ΔS of samples La_{0.95-y}Ce_{0.05}Pr_{y}Fe_{11.5}Si_{1.5} (y=0.1, 0.5) prepared in Example 3 while magnetic field changes from 0 to 5 T on temperature;

FIG. 12 shows the XRD spectrum of samples La_{0.8}Ce_{0.2}Fe_{11.4}Si_{1.6}B_{α} (α=0, 0.2 and 0.4) prepared in Example 4, at room temperature, wherein the peaks labeled with “*” represent unknown impurity phases;

FIG. 13 shows the thermomagnetic (M-T) curves of samples La_{0.8}Ce_{0.2}Fe_{11.4}Si_{1.6}B_{α} (α=0, 0.2 and 0.4) prepared in Example 4, in a magnetic field of 0.02 T;

FIG. 14 indicates the dependency of the magnetic entropy change ΔS of samples La_{0.8}Ce_{0.2}Fe_{11.4}Si_{1.6}B_{α} (α=0, 0.2 and 0.4) prepared in Example 4 while magnetic field changes from 0 to 1 T on temperature;

FIG. 15 shows the XRD spectrum of samples La_{0.9}Ce_{0.1}(Fe_{0.6}Co_{0.2}Mn_{0.2})_{13-y}Si_{y} (y=0.9, 1.8) prepared in Example 5, at room temperature, wherein the peaks labeled with “*” represent unknown impurity phases;

FIG. 16 shows the thermomagnetic (M-T) curves of samples La_{0.9}Ce_{0.1} (Fe_{0.6}Co_{0.2}Mn_{0.2})_{13-y}Si_{y} (y=0.9, 1.8) prepared in Example 5, in a magnetic field of 0.02 T;

FIG. 17 shows sample La_{0.7}Ce_{0.3}Fe_{11.5}Si_{1.5}C_{0.2}H_{0.45} prepared in Example 6: (a) the thermomagnetic (M-T) curve in a magnetic field of 0.02 T; (b) the dependency of the magnetic entropy change ΔS while magnetic field changes from 0 to 5 T on temperature;

FIG. 18 shows sample La_{0.7}Ce_{0.3}Fe_{11.5}Si_{1.5}C_{0.2}H_{0.45} prepared in Example 6: (a) the thermomagnetic (M-T) curve in a magnetic field of 0.02 T; (b) the dependency of the magnetic entropy change ΔS while magnetic field changes from 0 to 5 T on temperature;

FIG. 19 shows the XRD spectrum of sample La_{0.7}Ce_{0.21}(Pr_{0.25}Nd_{0.75})_{0.09}Fe_{11.6}Si_{1.4} prepared in Example 7, at room temperature, wherein the unknown impurity phases is labeled with “*”;

FIG. 20 shows the thermomagnetic (M-T) curve of sample La_{0.7}Ce_{0.21} (Pr_{0.25}Nd_{0.75})_{0.09}Fe_{11.6}Si_{1.4} prepared in Example 7, in a magnetic field of 0.02 T;

FIG. 21 indicates the dependency of the magnetic entropy change ΔS of sample La_{0.7}Ce_{0.21}(Pr_{0.25}Nd_{0.75})_{0.09}Fe_{11.6}Si_{1.4} prepared in Example 7 while magnetic field changes from 0 to 5 T on temperature;

FIG. 22 shows the XRD spectrum of sample La_{0.7}Ce_{0.3}Fe_{11.6}Si_{1.4}C_{0.1}H_{2.9} prepared in Example 8, at room temperature, wherein the unknown impurity phases is labeled with “*”;

FIG. 23 shows the thermomagnetic (M-T) curve of sample La_{0.7}Ce_{0.3}Fe_{11.6}Si_{1.4}C_{0.1}H_{2.9} prepared in Example 8, in a magnetic field of 0.02 T;

FIG. 24 indicates the dependency of the magnetic entropy change ΔS of sample La_{0.7}Ce_{0.3}Fe_{11.6}Si_{1.4}C_{0.1}H_{2.9} prepared in Example 8 while magnetic field changes from 0 to 5 T on temperature;

FIG. 25 shows the XRD (X-ray diffraction) spectrum of samples La_{0.7}(Ce,Pr,Nd)_{0.3}Fe_{11.6}Si_{1.4}C_{y} (y=0, 0.1, 0.2) prepared in Example 9, at room temperature, wherein the peaks labeled with “*” represent unknown impurity phases;

FIG. 26 shows the thermomagnetic (M-T) curves of samples La_{0.7}(Ce,Pr,Nd)_{0.3}Fe_{11.6}Si_{1.4}C_{y} (y=0, 0.1, 0.2) prepared in Example 9, in a magnetic field of 0.02 T;

FIG. 27 shows the magnetization curves (M-H curve) of samples La_{0.7}(Ce,Pr,Nd)_{0.3}Fe_{11.6}Si_{1.4}C_{y} (y=0, 0.1, 0.2) prepared in Example 9, in the process of increasing the field, at different temperatures;

FIG. 28 indicates the dependency of the magnetic entropy change ΔS of samples La_{0.7}(Ce,Pr,Nd)_{0.3}Fe_{11.6}Si_{1.4}C_{y} (y=0, 0.1, 0.2) prepared in Example 9 while magnetic field changes differently on temperature;

FIG. 29 shows the XRD spectrum of samples La_{0.7}(Ce,Pr,Nd)_{0.3}(Fe₁₋ₓCoₓ)_{11.6}Si_{1.4} (x=−0.02, 0.04, 0.06, 0.08, 0.1) prepared in Example 10, at room temperature, wherein the peaks labeled with “*” represent unknown impurity phases;

FIG. 30 shows the thermomagnetic (M-T) curves of samples La_{0.7}(Ce,Pr,Nd)_{0.3}(Fe₁₋ₓCoₓ)_{11.6}Si_{1.4} (x=0.02, 0.04, 0.06, 0.08, 0.1) prepared in Example 10, in a magnetic field of 0.02 T;

FIG. 31 shows the magnetization curves (M-H curves) of samples La_{0.7}(Ce,Pr,Nd)_{0.3}(Fe₁₋ₓCoₓ)_{11.6}Si_{1.4} (x=0.02, 0.04, 0.06, 0.08, 0.1) prepared in Example 10, in the process of increasing the field at different temperatures, and Arrott plots (FIG. 31f, 31g, 31h, 31i, 31j) generated from the M-H curves (FIGS. 31a, 31b, 31c, 31d, 31e);

FIG. 32 indicates the dependency of the magnetic entropy change ΔS of samples La_{0.7}(Ce,Pr,Nd)_{0.3}(Fe₁₋ₓCoₓ)_{11.6}Si_{1.4} (x=0.02, 0.04, 0.06, 0.08, 0.1) prepared in Example 10 while magnetic field changes differently on temperature;

FIG. 33 shows the comparison between the XRD spectrum of La_{0.7}(Ce,Pr,Nd)_{0.3}Fe_{11.6}Si_{1.4}H_{1.6} hydride prepared in Example 11 and the XRD spectrum of that before hydrogen absorption, wherein the peaks labeled with “*” represent unknown impurity phases;

FIG. 34 shows the comparison between the thermomagnetic (M-T) curve of La_{0.7}(Ce,Pr,Nd)_{0.3}Fe_{11.6}Si_{1.4}H_{1.6} hydride prepared in Example 11 and the thermomagnetic (M-T) curve of that before hydrogen absorption, in a magnetic field of 0.02 T;

FIGS. 35 a, b show the comparison between the magnetization curve (M-H curve) of La_{0.7}(Ce,Pr,Nd)_{0.3}Fe_{11.6}Si_{1.4}H_{1.6} hydride prepared in Example 11 and the magnetization curves (M-H curves) of that before hydrogen absorption, in the process of increasing, decreasing the field at different temperatures; FIG. 35c shows the curve of the magnetic hysteresis loss vs. temperature before and after hydrogen absorption;

FIG. 36 shows the comparison between the dependency of the magnetic entropy change ΔS of La_{0.7}(Ce,Pr,Nd)_{0.3}Fe_{11.6}Si_{1.4}H_{1.6} hydride prepared in Example 11 while magnetic field changes differently on temperature and the dependency of that before hydrogen absorption;

FIG. 37 shows the XRD spectrum of alloy samples La_{0.8}(Ce,Pr,Nd)_{0.2}Fe_{11.4}Si_{1.6}B_{α} (α=0.1, 0.3 and 0.5) prepared in Example 12, at room temperature, wherein the peaks labeled with “*” represent unknown impurity phases;

FIG. 38 shows the thermomagnetic (M-T) curves of alloy samples La_{0.8}(Ce,Pr,Nd)_{0.2}Fe_{11.4}Si_{1.6}B_{α} (α=0.1, 0.3 and 0.5) prepared in Example 12, in a magnetic field of 0.02 T;

FIG. 39 indicates the dependency of the magnetic entropy change ΔS of alloy samples La_{0.8}(Ce,Pr,Nd)_{0.2}Fe_{11.4}Si_{1.6}B_{α} (α=0.1, 0.3 and 0.5) prepared in Example 12 while magnetic field changes from 0 to 1 T on temperature;

FIG. 40 shows the XRD spectrum of La_{0.7}(Ce,Pr,Nd)_{0.3}Fe_{11.6}Si_{1.4}C_{0.1}H_{2.8} hydride prepared in Example 13, at room temperature;

FIG. 41 shows the thermomagnetic (M-T) curve of La_{0.7}(Ce,Pr,Nd)_{0.3}Fe_{11.6}Si_{1.4}C_{0.1}H_{2.8} hydride prepared in Example 13, in a magnetic field of 0.02 T;

FIG. 42 indicates the dependency of the magnetic entropy change ΔS of La_{0.7}(Ce,Pr,Nd)_{0.3}Fe_{11.6}Si_{1.4}C_{0.1}H_{2.8} hydride prepared in Example 13 while magnetic field changes differently on temperature;

FIG. 43 shows the XRD spectrum of La_{0.9}(Ce,Pr,Nd)_{0.1}(Fe_{0.6}Co_{0.2}Mn_{0.2})_{13-y}Si_{y} (y=1.8) prepared in Example 14, at room temperature, wherein the peaks labeled with “*” represent unknown impurity phases;

FIG. 44 shows the thermomagnetic (M-T) curves of La_{0.9}(Ce,Pr,Nd)_{0.1}(Fe_{0.6}Co_{0.2}Mn_{0.2})_{13-y}Si_{y}(y=0.9 and 1.8) prepared in Example 14, in a magnetic field of 0.02 T;

FIG. 45 shows the thermomagnetic (M-T) curves of La_{0.7}(Ce,Pr,Nd)_{0.3}Fe_{11.5}Si_{1.5}C_{0.2}B_{0.05}H_{0.55} hydride prepared in Example 15, in a magnetic field of 0.02 T; and

FIG. 46 indicates the dependency of the magnetic entropy change ΔS of La_{0.7}(Ce,Pr,Nd)_{0.3}Fe_{11.5}Si_{1.5}C_{0.2}B_{0.05}H_{0.55} hydride prepared in Example 15 while magnetic field changes differently on temperature.

### DETAILED DESCRIPTION OF THE INVENTION

For better understanding of the invention, the following definitions are used. The terms defined herein have the meaning generally understood by those skilled in the art.

Unless otherwise indicated, the “NaZn₁₃-type structure” or “1:13 structure” corresponding to the terms “LaFe₁₃₋ₓMₓ” as used herein means a structure in which the space group is Fm 3̅c. Fe atom occupies two crystal sites 8b (Fe^{I}) and 96i (Fe^{II}) in a ratio of 1:12, respectively. La and Fe^{I} atoms constitute CsCl structure, in which La atom is surrounded by 24 Fe^{II} atoms; Fe^{I} atom is surrounded by 12 Fe^{II} atoms constituting an icosahedron; and around each Fe^{II} atom, there are 9 nearest-neighbor Fe^{II} atoms, 1 Fe^{I} atom and 1 La atom. For LaFe₁₃₋ₓMₓ (M=Al, Si) compound, its neutron diffraction experiment showed that the 8b site is fully occupied by Fe atom; and 96i site is occupied by M atom and the rest Fe atom randomly.

In the invention, the three terms “magnetic material”, “magnetic refrigeration material” and “magnetocaloric material” have the same meaning and can be interchanged herein.

In the invention, the two terms “impurity-containing” and “industrial-pure” have the same meaning and can be interchanged herein. In terms of the La—Ce—Pr—Nd mischmetal, “impurity-containing” or “industrial-pure” means a purity of ≧95 wt. %; whereas in terms of the LaCe alloy, “impurity-containing” or “industrial-pure” means a purity of ≧95 at. %.

In one aspect, the invention provides a La (Fe, Si)₁₃-based magnetic refrigeration material prepared from industrial-pure mischmetal as the raw material, wherein the industrial-pure mischmetal is impurity-containing and naturally proportionated La—Ce—Pr—Nd mischmetal or LaCe alloy which, as the intermediate product during rare earth extraction, is extracted from light rare earth ore.

In the first embodiment of the invention, the industrial-pure mischmetal is impurity-containing and naturally proportionated La—Ce—Pr—Nd mischmetal which, as the intermediate product during rare earth extraction, is extracted from light rare earth ore. Preferably, the impurity-containing La—Ce—Pr—Nd mischmetal is industrial-pure mischmetal with high Ce content.

In the embodiment above, the impurity-containing and naturally proportionated La—Ce—Pr—Nd mischmetal extracted from light rare earth ore is commercially available, wherein the four elements La, Ce, Pr, Nd are the essential elements and their molar ratio in the mischmetal is same as their natural proportion in light rare earth ore. Preferably, the light rare earth ore includes: Bastnaesite, Urdite and other ore. Preferably, the impurity-containing La—Ce—Pr—Nd mischmetal has a purity of ≧95 wt. %. The impurities include but are not limited to one or more of Sm, Fe, Si, Mg, Zn, W, Mo, Cu, Ni, Ti, Th, Y, Ca, Pb, Cr, C, H, O. In certain cases, the impurities in the La—Ce—Pr—Nd mischmetal include but are not limited to one or more of Sm, Fe, Si, Mg, Zn, W, Mo, Cu, Ti, Ca, Pb, Cr, C, H, O.

Furthermore, in the embodiment above, the magnetic refrigeration material further comprises one or more elements selected from Sm, Mg, Zn, W, Mo, Cu, Ni, Ti, Th, Y, Ca, Pb, Cr and O. In certain cases, the magnetic refrigeration material further comprises one or more elements selected from Sm, Mg, Zn, W, Mo, Cu, Ti, Ca, Pb, Cr, O. All the above elements are introduced by the impurity-containing La—Ce—Pr—Nd mischmetal. When the material which need to be prepared is consisting of only La, Ce, Pr, Nd, Fe, Si, the A in the chemical formula of the magnetic refrigeration material does not include elements carbon (C) and/or hydrogen (H), then the elements C and/or H introduced by the impurity-containing La—Ce—Pr—Nd mischmetal also belong to impurities. In this case, the magnetic refrigeration material further comprises one or more elements selected from Sm, Mg, Zn, W, Mo, Cu, Ni, Ti, Th, Y, Ca, Pb, Cr, C, H and O.

In the second embodiment of the invention, the industrial-pure mischmetal is impurity-containing and naturally proportionated LaCe alloy, e.g. commercially available industrial-pure LaCe alloy, which, as the intermediate product during rare earth extraction, is extracted from light rare earth ore. Preferably, the impurity-containing LaCe alloy has a purity of ≧95 at %, preferably 95-98 at. % (in which, the at. % represents atomic percentage). In the LaCe alloy, the atomic ratio of La:Ce is same as their natural proportion in light rare earth ore, preferably 1:1.6-1:2.3. The impurities in the LaCe alloy include but are not limited to one or more of Pr, Nd, Sm, Fe, Si, Mg, Zn, W, Mo, Cu, Ni, Ti, Th, Y, Ca, Pb, Cr, C, H, O. In certain cases, the impurities in the LaCe alloy include but are not limited to one or more of Pr, Nd, Fe, Si, Cu, Ni, Zn, Th, Y, Mg, Ca, C, H, O.

Furthermore, in the second embodiment above, the magnetic material further comprises one or more elements selected from Pr, Nd, Sm, Mg, Zn, W, Mo, Cu, Ni, Ti, Th, Y, Ca, Pb, Cr and O. In certain cases, the magnetic material further comprises one or more elements selected from Pr, Nd, Cu, Ni, Zn, Th, Y, Mg, Ca, O. All the above elements are introduced by the impurity-containing LaCe alloy. When the material which need to be prepared is consisting of only La, Ce, Fe, Si, since the impurity-containing LaCe alloy is used for the preparation, the impurities in the alloy certainly will be introducted into the material, then the four elements Pr, Nd, C, H also belong to impurities for the alloy. In this case, the impurites contained in the magnetic material is one or more of Pr, Nd, C, H, Sm, Mg, Zn, W, Mo, Cu, Ni, Ti, Th, Y, Ca, Pb, Cr and O.

It is worth specifying that the impurity-containing LaCe alloy can be extracted from rare earth ore directly, or it can also be the LaCe alloy mainly consisting of La and Ce and obtained by removing elements Pr and Nd from the impurity-containing La—Ce—Pr—Nd mischmetal. The type and amount of the impurities contained in the La—Ce—Pr—Nd mischmetal or LaCe alloy both rely on the raw rare earth ore. However, as long as the purity satisfies the requirement above, variations in the type or amount of the impurities has no impact on the implement of the invention or the magnetic refrigeration effect of the material. Therefore, the inventive concept of the invention is mainly to prepare a La (Fe, Si)₁₃-based magnetic refrigeration material from naturally proportionated and industrial-pure mischmetal as the raw material, so as to reduce the dependency on elementary rare earth with a high purity as the raw material; lower the production cost; and enable industrial production. In the invention, there are two exemplary embodiments shown as follows: embodiment 1) involving use of the impurity-containing La—Ce—Pr—Nd mischmetal extracted from light rare earth ore and embodiment 2) involving use of the impurity-containing LaCe alloy, both of which thus belong to the same inventive concept. Both the La—Ce—Pr—Nd mischmetal and the LaCe alloy, used as the raw materials, are impurity-containing and naturally proportionated mischmetal extracted from light rare earth ore. The magnetic refrigeration materials prepared from different raw materials and having the NaZn₁₃-type structure have almost the same properties.

The difference in the molecular formula is caused by uncertained elementary ratio of naturally proportionated mischmetal raw materials, i.e. La—Ce—Pr—Nd and La—Ce (replying on the natural composition of the ore). Therefore, the two different molecular formula also belong to the same inventive concept.

In some embodiments of the invention, the α is in a range of 0≦α≦0.8.

Further, the invention provides a magnetic refrigeration material, wherein while magnetic field changes from 0 to 5 T, the magnetic entropy change value of the magnetic refrigeration material can be 5.0-50.0 J/kgK, and the temperature range of phase transition is within 10-400K.

In another aspect, the invention further provides a method for preparing the magnetic refrigeration material described above, and the method comprises the steps of:

1) preparing raw material according to the chemical formula,

where A includes element H, the raw material other than H is prepared according to the chemical formula, the raw material comprises industrial-pure mischmetal, i.e. an impurity-containing and naturally proportionated La—Ce—Pr—Nd mischmetal or LaCe alloy which, as an intermediate product during rare earth extraction, is extracted from light rare earth ore; wherein, as the industrial-pure mischmetal is an impurity-containing La—Ce—Pr—Nd mischmetal extracted from light rare earth ore, the material is represented by the chemical formula: La₁₋ₓ(Ce,Pr,Nd)ₓ(Fe_{1-p-q}CoₚMn_{q})_{13-y}Si_{y}A_{α}, and where the industrial-pure mischmetal is the impurity-containing and naturally proportionated LaCe alloy extracted from light rare earth ore, the material is represented by the chemical formula: La_{1-x-z}CeₓR_{z}(Fe_{1-p-q}CoₚMn_{q})_{13-y}Si_{y}A_{α};

2) manufacturing alloy ingots by arc melting technology, wherein the raw material prepared in step i) is placed in an arc furnace, vacuumed, purged with argon gas, and smelted under the protection of argon gas, so as to obtain the alloy ingots;

3) annealing the alloy ingots in the vacuum obtained in step 2) and then followed by quenching in liquid nitrogen or water, so as to obtain the magnetocaloric material La_{1-x-z}CeₓR_{z}(Fe_{1-p-q}CoₚMn_{q})_{13-y}Si_{y}A_{α} or La₁₋ₓ(Ce,Pr,Nd)ₓ(Fe_{1-p-q}CoₚMn_{q})_{13-y}Si_{y}A_{α} having a NaZn₁₃-type structure;

wherein, as A in the above chemical formula includes element H, the method further comprises the step of 4) pulverizing the material obtained from step 3) and then annealing the resultant powder in hydrogen gas.

According to the preparation method provided in the invention, in one embodiment, elements La, Ce, Pr and Nd in the raw material are provided by the naturally proportionated and impurity-containing La—Ce—Pr—Nd mischmetal extracted from light rare earth ore. In another embodiment, elements La and Ce in the raw material are provided by the impurity-containing and naturally proportionated LaCe alloy extracted from light rare earth ore. Preferably, the insufficience of element La (provided by the LaCe alloy or La—Ce—Pr—Nd mischmetal) is supplemented by elementary La. Other elements in the chemical formula are provided by conventional methods in the field, using the materials containing such elements as the raw materials, provided that all elements and the content ratio of each element in the raw materials are same as those in the chemical formula.

Furthermore, according to the preparation method above, in the raw materials, where A includes element C, the element C is preferably provided by FeC alloy. Because elementary C is very difficult to be smelted into alloy due to its high melting point, the FeC alloy made of elementary Fe and C can be employed, so as to ensure sufficient amount of C element to be introduced. In this case, since the FeC alloy also contains Fe element, the added amount of elementary Fe needs to be properly reduced, so that the ratio of the added elements still meets the requirement for the atomic ratio in the chemical formula or the magnetic refrigeration material. Similarly, where A includes element B, the element B can also be preferably provided by FeB alloy.

Further, according to the preparation method above, other materials, such as La, Fe, FeC, FeB, Co, Mn, Si, Pr, Nd and B, other than La—Ce—Pr—Nd mischmetal and/or LaCe alloy in the raw material have a purity higher than 98 wt. %.

Further, according to the preparation method above, the step 2) can comprise the steps of placing the raw material prepared in step 1) into an arc furnace; vacuuming the arc furnace to reach a vacuum degree of less than 1×10⁻² Pa; purging the furnace chamber once or twice with an argon gas having a purity of higher than 99 wt. %; then filling the furnace chamber with the argon gas to reach 0.5-1.5 atms; and arcing; so as to obtain the alloy ingots; wherein each alloy ingot is smelted at 1500-2500° C. for 1-6 times repeatedly and the melting temperature is preferably 1800-2500° C.

Further, according to the preparation method above, the step 3) can comprise the steps of annealing the smelted alloy ingots obtained from step 2) at 1000-1400° C. and under a vacuum degree of less than 1×10⁻³ Pa, for from 1 hour to 60 days; then quenching the alloy ingots in liquid nitrogen or water so as to prepare the magnetic refrigeration material La_{1-x-z}CeₓR_{z}(Fe_{1-p-q}CoₚMn_{q})_{13-y}Si_{y}A_{α} or La₁₋ₓ(Ce,Pr,Nd)ₓ(Fe_{1-p-q}CoₚMn_{q})₁₃₋ySiyAα with a main phase being of NaZn₁₃-type structure.

Further, according to the preparation method above, the step 4) can comprise the steps of pulverizing the material prepared in step 3) into powder; annealing in hydrogen gas, so as to prepare hydride of La_{1-x-z}CeₓR_{z}(Fe_{1-p-q}CoₚMn_{q})_{13-y}Si_{y}A_{α} or La₁₋ₓ(Ce,Pr,Nd)ₓ(Fe_{1-p-q}CoₚMn_{q})_{13-y}Si_{y}A_{α}. Preferably, the amount of hydrogen in the alloy is controlled by adjusting the pressure of the hydrogen gas, annealing temperature and annealing period.

Furthermore, according to the preparation method above, the step 4) can comprise the steps of pulverizing the material prepared in step 3) into irregular powder with a particle size of less than 2 mm; placing the powder in hydrogen gas with a purity higher than 99 wt. % and at 0-100 atm, preferably 10⁻⁴-100 atm; annealing at 0-600° C. for 1 minute to 10 days, preferably at 100-350° C. for 1 minute to 3 days, so as to prepare hydride of La_{1-x-z}Ceₓ(Fe_{1-p-q}CoₚMn_{q})_{13-y}Si_{y}A_{α} or La₁₋ₓ(Ce,Pr,Nd)ₓ(Fe_{1-p-q}CoₚMn_{q})_{13-y}Si_{y}A_{α}.

In another aspect, the invention provides a magnetic refrigerator, wherein the magnetic refrigeration material used in the magnetic refrigerator comprises the La(Fe,Si)₁₃-based magnetic refrigeration material of the invention or the magnetic refrigeration material prepared by the method of the invention.

In a further aspect, the invention provides use of the magnetic refrigeration material of the invention or the magnetic refrigeration material prepared by the method of the invention in the manufacture of a complex refrigeration material.

Compared with prior art, the invention has advantages shown as follows:
(1) The invention utilizes the intermediate product during rare earth extraction—extracting impurity-containing and naturally proportionated La—Ce—Pr—Nd mischmetal or LaCe alloy from light rare earth ore such as Bastnaesite, urdite and the like and using the La—Ce—Pr—Nd mischmetal or LaCe alloy as the raw material to prepare a La(Fe,Si)₁₃-based magnetic refrigeration material. As a result, the invention reduces the dependency on elementary rare earth with a high purity as the raw material and lowers the material cost, so that it is very important for the development of magnetic refrigeration application of materials in practice.
(2) Replacement of partial La (nonmagnetic) with one or more of magnetic Ce, Pr, Nd, the exchange coupling between same/different rare earth ions (R—R) and exchange coupling between rare earth ion and Fe (R-T) impart a high saturation magnetic moment to the compound, so as to achieve greater magnetocaloric effect. In addition, it was also found that greater magnetocaloric effect can be achieved at room temperature by introduction of Ce, Pr, Nd together (i.e. the LaFeSi magnetic refrigeration material prepared from the La—Ce—Pr—Nd mischmetal as the raw material in the invention) than introduction of Ce alone (i.e. the LaFeSi magnetic refrigeration material prepared from the LaCe alloy as the raw material in the invention).
(3) In the La(Fe,Si)₁₃-based magnetic refrigeration material prepared in the invention, the impurities introduced by the raw material La—Ce—Pr—Nd mischmetal or LaCe alloy have no impact on formation of the NaZn₁₃ phase or first-order phase-transition property. Metamagnetic behaviour still occurs, so that giant magnetocaloric effect is maintained. This is completely different from the famous giant magnetocaloric material Gd₅Si₂Ge₂, as the presence and introduction of impurities in Gd₅Si₂Ge₂ alloy (such as C, H, O, Fe, Co, Ni, Cu, Ga, Al, etc.) result in disappearance of the first-order phase-transition property and in turn giant magnetocaloric effect (J. Magn. Magn. Mater. 167, L 179 (1997); J. Appl. Phys. 85, 5365 (1999)).

### Specific Mode for Carrying Out the Invention

The invention is further described by referring to the Examples. It needs to be clarified that the following Examples are provided for the purpose of illustrating the invention only and are not intended to restrict the scope of the invention by any means. Any modification made by a person skilled in the art in light of the invention shall belong to the extent sought to be protected by the claims of the application.

The raw materials and equipments used in the Examples are described as follows:
1) Commercially available LaCe alloy, i.e. the naturally proportionated La—Ce alloy extracted industrially from Bastnaesite, the worldwide largest light rare earth ore located in Inner Mongolia, China, was purchased from Inner Mongolia Baotou Steel Rare Earth International Trade Ltd., with two different purities: (a) The LaCe alloy used in Examples 1-2 has a purity of 97.03 at. %, a La:Ce atomic ratio of 1:1.88, and impurities of 0.05 at. % Pr, 0.05 at. % Nd, 0.71 at. % Fe, 0.24 at. % Si, 0.11 at. % Cu, 0.05 at. % Ni, 0.002 at. % Th, 0.63 at. % Zn, 1.14 at. % O; and (b) The LaCe alloy used in Examples 3-8 has a purity of 95.91 at. %, a La:Ce atomic ratio of 1:2.24, and impurities of 0.07 at. % Pr, 0.07 at. % Nd, 0.92 at. % Fe, 0.35 at. % Si, 0.27 at. % Cu, 0.13 at. % Ni, 0.003 at. % Th, 0.91 at. % Zn, 1.37 at. % O.
2) Industrial-pure La—Ce—Pr—Nd mischmetal, i.e. the naturally proportionated La—Ce—Pr—Nd mischmetal extracted industrially from Bastnaesite, the worldwide largest light rare earth ore located in Inner Mongolia, China, was purchased from Inner Mongolia Baotou Steel Rare Earth International Trade Ltd., with two different purities: (a) the mischmetal used in Examples 9-11 has a purity of 99.6 wt. %, La, Ce, Pr, Nd elements (28.27 wt. % La, 50.46 wt. % Ce, 5.22 wt. % Pr, 15.66 wt. % Nd), and impurities of <0.05 wt. % Sm, 0.037 wt. % Fe, 0.016 wt. % Si, 0.057 wt. % Mg, <0.010 wt. % Zn, 0.01 wt. % W, 0.007 wt. % Mo, <0.01 wt. % Cu, <0.01 wt. % Ti, <0.01 wt. % Ca, <0.01 wt. % Pb, <0.03 wt. % Cr, <0.01 wt. % C; and (b) the industrial-pure La—Ce—Pr—Nd mischmetal used in Examples 12-15 has a purity of 98.4 wt. %, and La, Ce, Pr, Nd elements (25.37 wt. % La, 52.90 wt. % Ce, 4.57 wt. % Pr, 15.56 wt. % Nd).
3) Other raw materials and purities thereof are shown as follows: elementary La (with a purity of 99.52 wt %), elementary Pr (98.97 wt. %), and elementary Nd (98.9 wt. %), purchased from Hunan Shenghua Rare Earth Metal Material Ltd.; Fe (99.9 wt %), purchased from Beijing Research Institute for Nonferrous Metals; FeC (99.9 wt %, Fe, C weight ratio of 95.76:4.24), smelted from elementary C and Fe having a purity of 99.9 wt %; Si (99.91 wt %), purchased from Beijing Research Institute for Nonferrous Metals; FeB alloy (99.9 wt. %, Fe, B weight ratio of 77.6:22.4), purchased from Beijing Zhongke Sanhuan High Technology Ltd.; Co (99.97 wt %), purchased from Beijing Research Institute for Nonferrous Metals; Mn (99.8 wt. %), purchased from Beijing Shuanghuan Chemical Reagent Factory.

All the above raw materials were in blocks.
4) The arc furnace (Model: WK-II non-consumable vacuum arc furnace) was manufactured by Beijing Wuke Electrooptical Technology Ltd.; the Cu-targeted X-ray diffractometer (Model: RINT2400) was manufactured by Rigaku; and the Superconducting Quantum Interference vibrating Sample Magnetometer (Model: MPMS (SQUID) VSM) was manufactured by Quantum Design (USA).

### Example 1

### Preparation of Two Magnetic Refrigeration Materials of La_{0.7}Ce_{0.3}Fe_{11.6}Si_{1.4}C_{y} (y=0.2 and 0.3)

1) The materials were prepared in accordance with the chemical formula La_{0.7}Ce_{0.3}Fe_{11.6}Si_{1.4}C_{y} (y=0.2 and 0.3). The raw materials included impurity-containing LaCe alloy (with a purity of 97.03 at. %), Fe, Si, La and FeC, wherein elementary La was added to make up the La insufficience in the LaCe alloy; C was provided by the FeC alloy; the amount of the elementary Fe added thereto was reduced properly since the FeC alloy contains Fe element, so that the proportion of each element added still met the requirement for the atomic ratio in the chemical formula of the magnetic material.

2) The raw materials prepared in step 1), after mixed, was loaded into an arc furnace. The arc furnace was vacuumized to a pressure of 2×10⁻³ Pa, purged with high-purity argon with a purity of 99.996 wt % twice, and then filled with high-purity argon with a purity of 99.996 wt % to a pressure of 1 atm. The arc was struck (the raw materials were smelted together to form alloy after striking, same as below) to generate alloy ingot. Each alloy ingot was smelted at a temperature of 2000° C. repeatedly for 4 times. After the smelting, the ingot alloys were obtained by cooling down in a copper crucible.

3) After wrapped separately with molybdenum foil and sealed in a vacuumized quartz tube (1×10⁻⁴ Pa), the ingot alloy obtained from step 2) was annealed at 1080° C. for 30 days followed by being quenched in liquid nitrogen by breaking the quartz tube. As a result, samples La_{0.7}Ce_{0.3}Fe_{11.6}Si_{1.4}C_{y} (y=0.2, 0.3) having a NaZn₁₃-type structure were obtained.

Performance Test

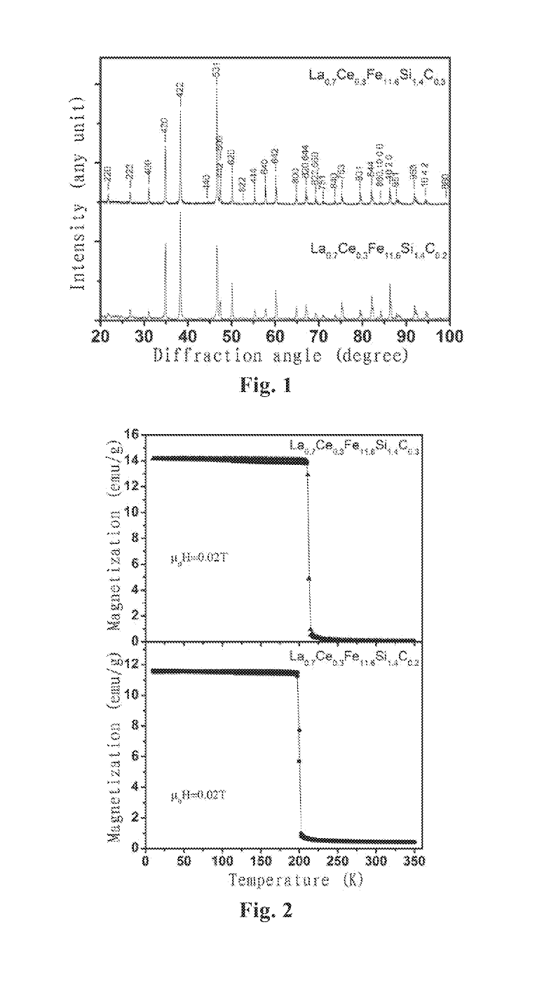

I. The X-ray diffraction (XRD) spectrum of the samples at room temperature was measured using the Cu-target X-ray diffractometer. The result, as shown in FIG. 1, indicated that both of the two samples La_{0.7}Ce_{0.3}Fe_{11.6}Si_{1.4}C_{y} (y=0.2, 0.3) had a clean NaZn₁₃-type singe-phase structure. The α-Fe impurity phase, commonly exists in such systems especially a system containing C, was not detected in either of these two samples, meaning that the presence of impurities in the raw material LaCe alloy had no impact on the formation and growth of the NaZn₁₃ phase.

II. The thermomagnetic curves (M-T) of samples La_{0.7}Ce_{0.3}Fe_{11.6}Si_{1.4}C_{y} (y=0.2, 0.3) were measured in a magnetic field of 0.02 T, using the Superconducting Quantum Interference Vibrating Sample Magnetometer. As shown in FIG. 2, it can be determined that only minor temperature hysteresis occurred; and Curie temperature (T_{C}) was raised from 200K to 212K while C content was increased from y=0.2 to y=0.3.

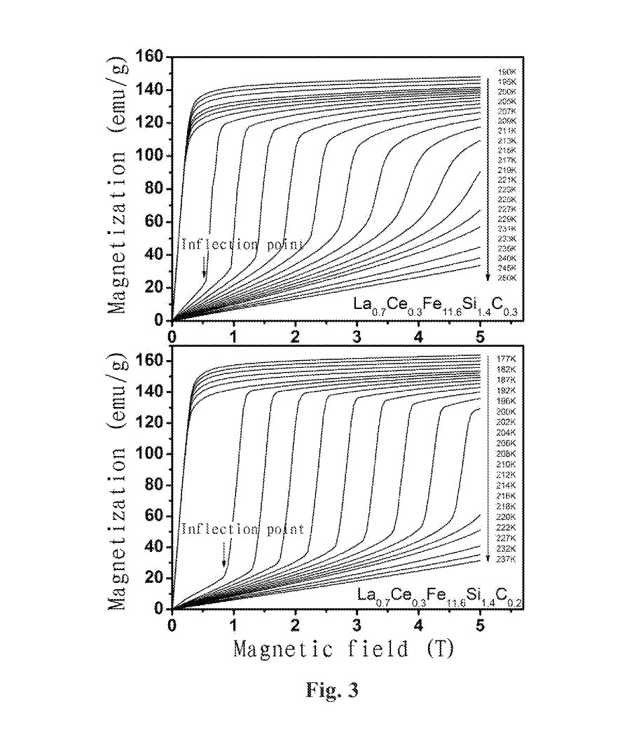

The magnetization curves (M-H curves) of samples La_{0.7}Ce_{0.3}Fe_{11.6}Si_{1.4}C_{y} (y=0.2, 0.3) were measured on the MPMS (SQUID) VSM at different temperatures in the process of increasing field. As shown in FIG. 3, the presence of a clear inflection point in the M-H curves indicated that metamagnetic transition from paramagnetic to ferromagnetic state was induced by the magnetic field, meaning that the presence of impurities in the raw material LaCe alloy had no impact on the formation of the 1:13 phase or the presence of metamagnetic behaviour, so that a giant magnetocaloric effect was ensured for the materials.

On the basis of the Maxwell's equation

$$Δ S ( T , H ) = S ( T , H ) - S ( T , 0 ) = {\int }_{0}^{H} {( \frac{\partial M}{\partial T} )}_{H} d H ,$$

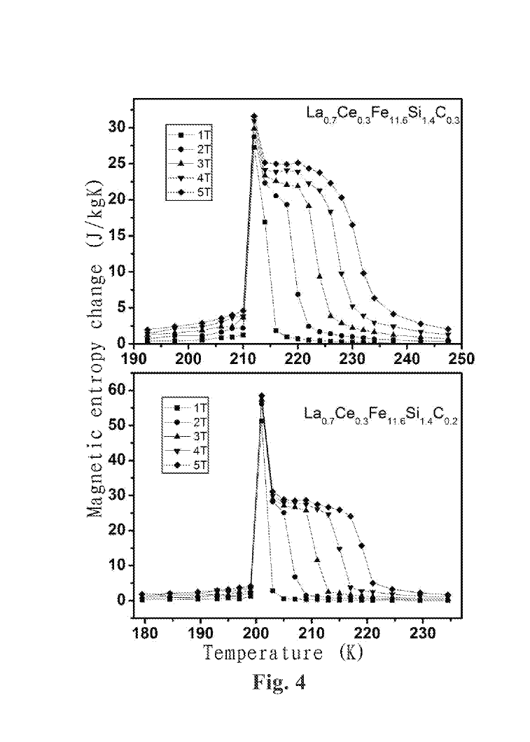

the magnetic entropy change, ΔS, can be calculated according to the isothermal magnetization curve. FIG. 4 shows the dependency of ΔS on temperature for La_{0.7}Ce_{0.3}Fe_{11.6}Si_{1.4}C_{y} (y=0.2, 0.3) in different magnetic fields. From FIG. 4, it was observed that the ΔS peak shape extended asymmetrically towards the high-temperature zone while the field was increased; the peak was followed by a plateau, which is a typical feature of a La(Fe,Si)₁₃-based first-order phase transition system and caused by the metamagnetic transition induced by the magnetic field at a temperature higher than Curie temperature. The ΔS peak shape further confirmed the existence of the first-order phase-transition property and metamagnetic behaviour of the system, which in turn indicated that the presence of impurities in the raw material LaCe alloy had no impact on the formation of the 1:13 phase or the presence of metamagnetic behaviour, so that a giant magnetocaloric effect was ensured for the materials. It has been demonstrated by some studies that the appearance of the ΔS peak caused by the coexistence of two phases during the first-order phase transition is a false signal; the plateau reflects the essential property of magnetocaloric effect. For samples y=0.2, 0.3, the ΔS plateau were 28.7 J/kgK and 25.1 J/kgK while the magnetic field change was 0 to 5 T, both significantly higher than the magnetic entropy change of the traditional magnetic refrigeration material Gd at room temperature (the magnetic entropy change was 9.8 J/kgK in a magnetic field of 5 T); the full widths at half maximum were 19.4K and 20.4K; and refrigeration capacities were 508.8 J/kg and 462.8 J/kg, respectively. A high and wide plateau of magnetic entropy change is particularly required by Ericsson-type magnetic refrigerators, which plays an important role in magnetic refrigerating application in practice.

Conclusion: It can be confirmed by this Example that La(Fe,Si)₁₃-based carbide having a NaZn₁₃-type crystal structure was prepared from industrial-pure LaCe alloy as the raw material in accordance with the preparation method described; the presence of impurities in the raw material LaCe alloy had no impact on the formation and growth of the NaZn₁₃ phase; metamagnetic transition behaviour was maintained; a giant magnetocaloric effect was exhibited; Curie temperature moved towards the higher temperature zone while C content was increased.

### Example 2

### Preparation of Three Magnetic Refrigeration Materials of La_{0.7}Ce_{0.3} (Fe₁₋ₓCoₓ)_{11.6}Si_{1.4} (x=0.04, 0.06 and 0.08)

1) The materials were prepared in accordance with the chemical formula La_{0.7}Ce_{0.3} (Fe₁₋ₓCoₓ)_{11.6}Si_{1.4} (x=0.04, 0.06 and 0.08). The raw materials included impurity-containing LaCe alloy (with a purity of 97.03 at. %), Fe, Co, Si, and La, wherein elementary La was added to make up the La insufficience in the LaCe alloy.

2) The raw materials prepared in step 1), after mixed, was loaded into an arc furnace. The arc furnace was vacuumized to a pressure of 2×10⁻³ Pa, purged with high-purity argon with a purity of 99.996 wt % twice, and then filled with high-purity argon with a purity of 99.996 wt % to a pressure of 1 atm. The arc was struck (the raw materials were smelted together to form alloy after striking, same as below) to generate alloy ingot. Each alloy ingot was smelted at a temperature of 2000° C. repeatedly for 4 times. After the smelting, the ingot alloys were obtained by cooling down in a copper crucible.

3) After wrapped separately with molybdenum foil and sealed in a vacuumized quartz tube (1×10⁻⁴ Pa), the ingot alloy obtained from step 2) was annealed at 1080° C. for 30 days followed by being quenched in liquid nitrogen by breaking the quartz tube. As a result, samples La_{0.7}Ce_{0.3}(Fe₁₋ₓCoₓ)_{11.6}Si_{1.4} (x=0.04, 0.06, 0.08) having a NaZn₁₃-type structure were obtained.

Performance Test

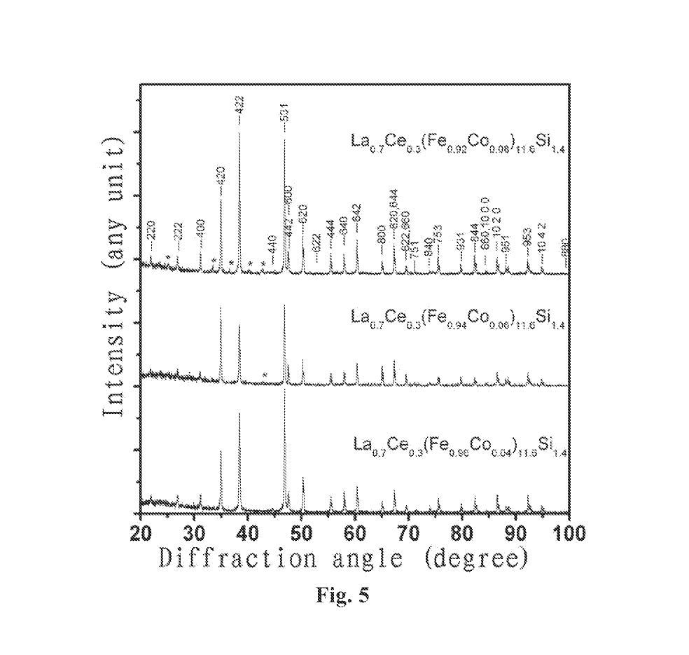

I. The X-ray diffraction (XRD) spectrum of the samples at room temperature was measured using the Cu-target X-ray diffractometer. The result, as shown in FIG. 5, indicated that all three samples La_{0.7}Ce_{0.3}(Fe₁₋ₓCoₓ)_{11.6}Si_{1.4} (x=0.04, 0.06, 0.08) had a main phase with a NaZn₁₃-type structure. The α-Fe impurity phase, commonly exists in such systems, was not detected in any of these three samples. The correlation between the small amount of impurity phases detected (peaks labeled with * in FIG. 5) and the existence of impurities in the raw material LaCe alloy needs to be further confirmed. The small amount of unknown impurity phases coexisted with NaZn₁₃-type main phase, but the presence of impurity phases had no impact on the formation and growth of the NaZn₁₃-type main phase.

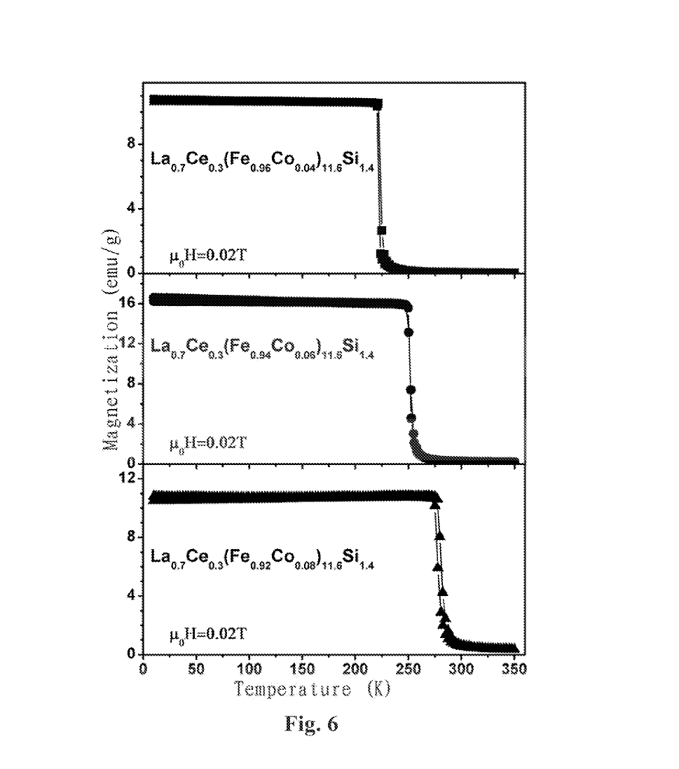

II. The thermomagnetic curves (M-T) of samples La_{0.7}Ce_{0.3}(Fe₁₋ₓCoₓ)_{11.6}Si_{1.4} (x=0.04, 0.06, 0.08) were measured in a magnetic field of 0.02 T, using the Superconducting Quantum Interference Vibrating Sample Magnetometer (MPMS (SQUID) VSM). As shown in FIG. 6, it can be determined that only minor temperature hysteresis occurred; and Curie temperature (T_{C}) was raised from 222K to 280K while Co content was increased from x=0.04 to x=0.08.

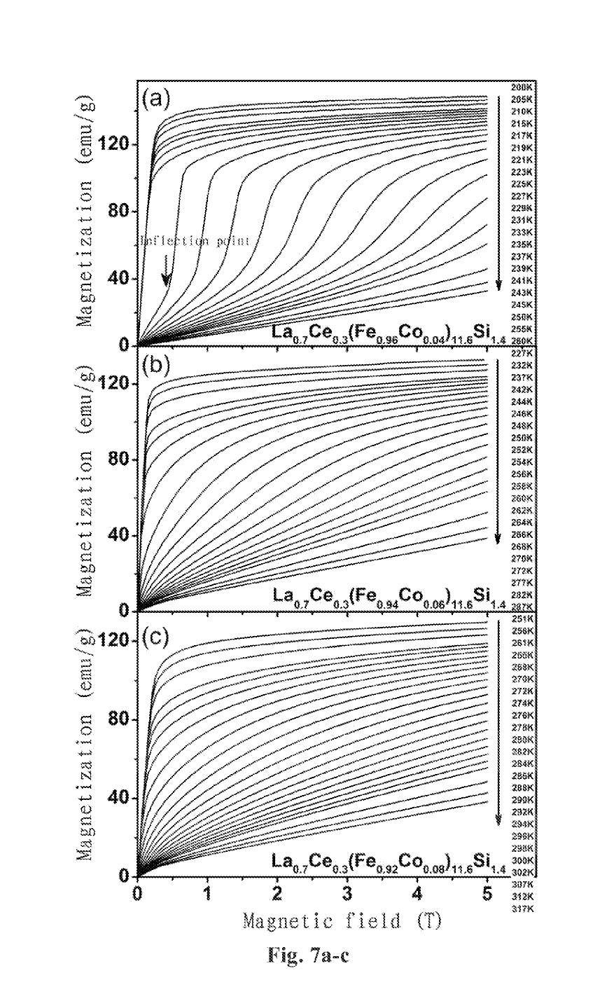

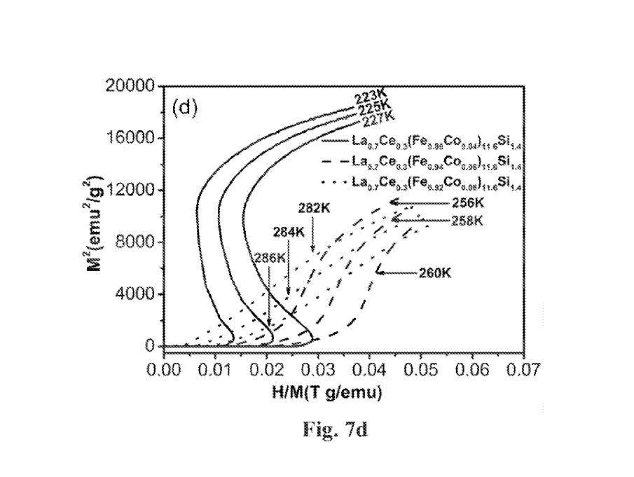

The magnetization curves (M-H curves) of samples La_{0.7}Ce_{0.3}(Fe₁₋ₓCoₓ)_{11.6}Si_{1.4} (x=0.04, 0.06, 0.08) were measured on the MPMS (SQUID) VSM at different temperatures in the process of increasing the field, as shown in FIGS. 7a-c. The presence of an inflection point in the M-H curve (or the inflection point or negative slope in the Arrott plot (FIG. 7d)) indicated that metamagnetic transition from paramagnetic to ferromagnetic state was induced by the magnetic field, meaning that the presence of impurities in the raw material LaCe alloy had no impact on the formation of the 1:13 phase or the presence of metamagnetic transition behaviour, so that a giant magnetocaloric effect was ensured for the materials. In addition, while the Co content was reduced, the metamagnetic behaviour was weakened and the inflection point disappeared.

On the basis of the Maxwell's equation,

$$Δ S ( T , H ) = S ( T , H ) - S ( T , 0 ) = {\int }_{0}^{H} {( \frac{\partial M}{\partial T} )}_{H} d H ,$$

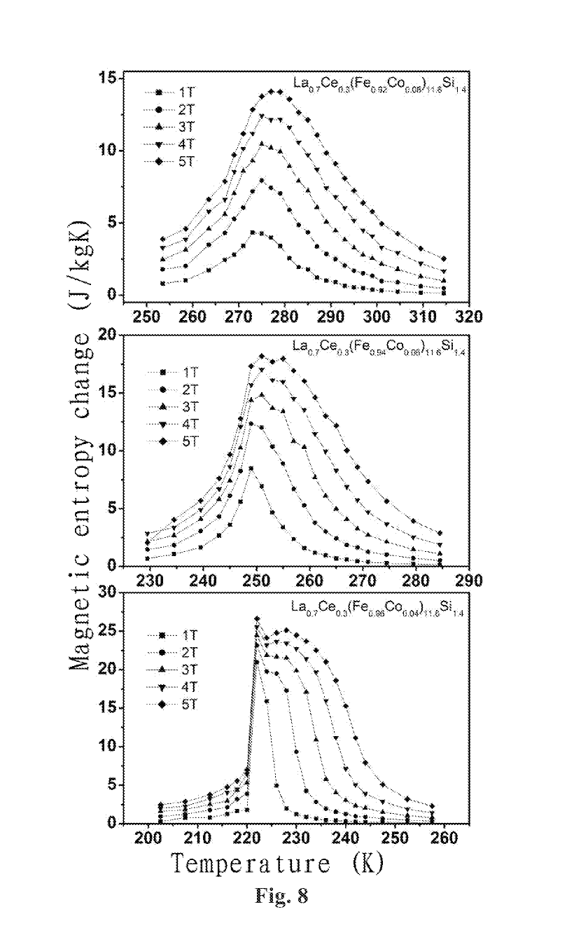

the magnetic entropy change, ΔS, can be calculated according to the isothermal magnetization curve. FIG. 8 shows the dependency of ΔS on temperature for La_{0.7}Ce_{0.3}(Fe₁₋ₓCoₓ)_{11.6}Si_{1.4} (x=0.04, 0.06, 0.08) in different magnetic fields. From FIG. 8, it was observed that the ΔS peak shape extended asymmetrically towards the high-temperature zone while the field was increased and the metamagnetic transition from paramagnetic to ferromagnetic state was induced by the magnetic field at a temperature higher than Curie temperature, which demonstrates the presence of metamagnetic transition behaviour in the system. Upon the increase of the Co content, metamagnetic behaviour was weakened and the ΔS peak shape tended to become symmetric gradually. The asymmetrical extension of the ΔS peak shape further demonstrated that the presence of impurities in the raw material LaCe alloy had no impact on the formation of the 1:13 phase or the presence of metamagnetic transition behaviour, so that a giant magnetocaloric effect was ensured for the materials. For the three samples x=0.04, 0.06, 0.08, the ΔS peak values were 25.1 J/kgK, 18.2 J/kgK and 14.1 J/kgK while the magnetic field change was 0 to 5 T, all higher than the magnetic entropy change of the traditional magnetic refrigeration material Gd at room temperature (the magnetic entropy change was 9.8 J/kgK in a magnetic field of 5 T) at 222K, 255K and 277K; the full widths at half maximum were 20.6K, 23.8K and 30.8K; and refrigeration capacities were 448.8 J/kg, 350.8 J/kg and 340.3 J/kg, respectively.

Conclusion: It can be confirmed in this Example that La(Fe,Si)₁₃-based compound having a NaZn₁₃-type crystal structure was prepared from industrial-pure LaCe alloy as the raw material in accordance with the preparation method described, wherein the replacement of Fe with Co enabled Curie temperature to raise up to around room temperature. The presence of impurities in the raw material LaCe alloy had no impact on the formation and growth of the NaZn₁₃ phase; and a giant magnetocaloric effect was exhibited.

### Example 3

### Preparation of Two Magnetic Refrigeration Materials of La_{0.95-y}Ce_{0.05}Pr_{y}Fe_{11.5}Si_{1.5} (y=0.1 and 0.5)

1) The materials were prepared in accordance with the chemical formula La_{0.95}Ce_{0.05}Pr_{y}Fe_{11.5}Si_{1.5} (y=0.1 and 0.5). The raw materials included impurity-containing LaCe alloy (with a purity of 95.9 lat. %), Fe, Co, Si, La and Pr, wherein elementary La was added to make up the La insufficience in the LaCe alloy.

2) The raw materials prepared in step 1), after mixed, was loaded into an arc furnace. The arc furnace was vacuumized to a pressure of 2×10⁻³ Pa, purged with high-purity argon with a purity of 99.996 wt % twice, and then filled with high-purity argon with a purity of 99.996 wt % to a pressure of 1 atm. The arc was struck (the raw materials were smelted together to form alloy after striking, same as below) to generate alloy ingot. Each alloy ingot was smelted at a temperature of 1800° C., 1900° C., 2000° C., 2100° C., 2300° C. or 2500° C. repeatedly for 6 times. After the smelting, the ingot alloys were obtained by cooling down in a copper crucible.

3) After wrapped separately with molybdenum foil and sealed in a vacuumized quartz tube (9×10⁻⁴ Pa), the ingot alloy obtained from step 2) was annealed at 1100° C. for 50 days followed by being quenched in liquid nitrogen by breaking the quartz tube. As a result, samples La_{0.95-y}Ce_{0.05}Pr_{y}Fe_{11.5}Si_{1.5} (y=0.1, 0.5) having a NaZn₁₃-type structure were obtained.

The Performance Test was Conducted Using the Same Method as Those Described in Examples 1 and 2.

I. The X-ray diffraction (XRD) spectrum, as shown in FIG. 9, indicated that both samples in this Example were crystallized into a NaZn₁₃-type structure. The small amount of impurities detected was labeled with * in FIG. 9.

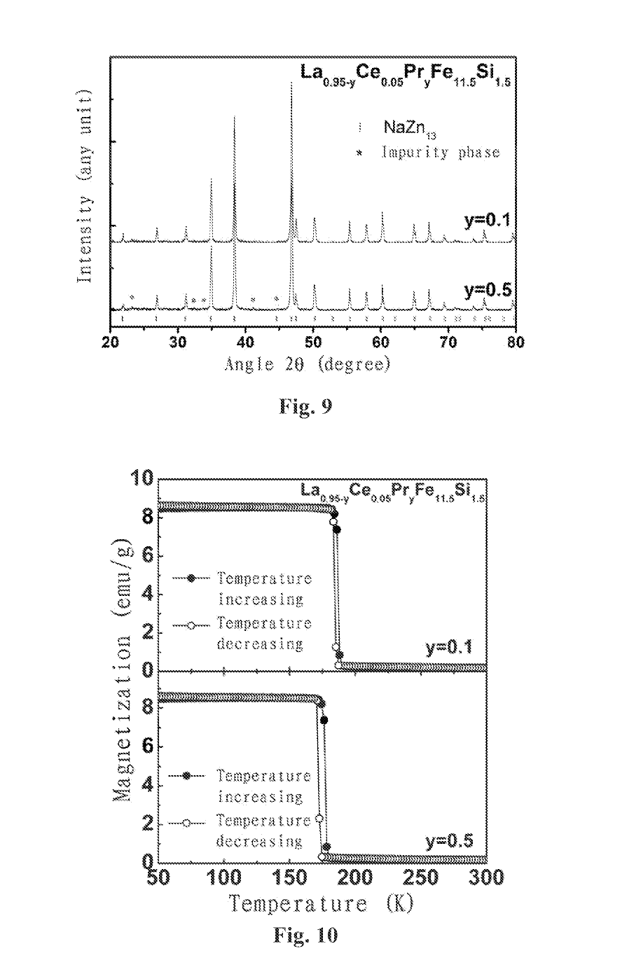

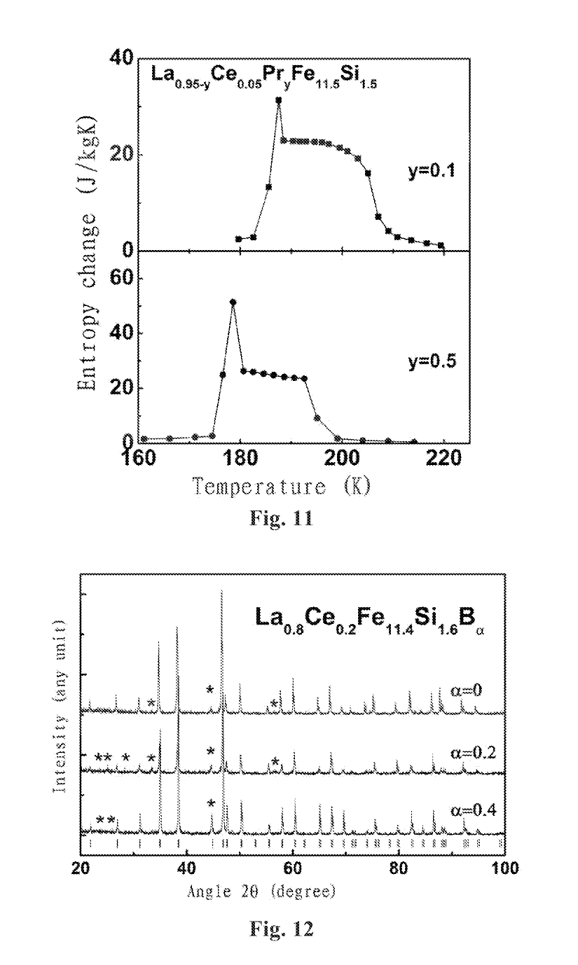

II. FIG. 10 shows the thermomagnetic curves (M-T) in a magnetic field of 0.02 T. It was observed that Curie temperature (T_{C}) was lowered from 187K to 177K while the Pr content was increased from y=0.1 to y=0.5. The temperature hysteresis was increased from about 3K to about 5K, which indicated that the first-order phase-transition property was enhanced. FIG. 11 shows the dependency of magnetic entropy change ΔS on temperature for the two samples while magnetic field changes from 0 to 5 T. While magnetic field changes from 0 to 5 T, the effective magnetic entropy change (plateau) were 22.7 J/kgK (y=0.1) and 26.0 J/kgK (y=0.5) respectively; and the range of the effective magnetic entropy change was enlarged upon the increase of Pr content.

Conclusion: It can be confirmed in this Example that La(Fe,Si)₁₃-based compound having a NaZn₁₃-type crystal structure was prepared from industrial-pure LaCe alloy as the raw material in accordance with the preparation method described. The presence of impurities in the raw material LaCe alloy had no impact on the formation and growth of the NaZn₁₃ phase. Upon La was replaced by rare earth Ce, Curie temperature moved towards the lower temperature zone; the first-order phase-transition property was enhanced and the range of the effective magnetic entropy change was enlarged.

### Example 4

### Preparation of Three Magnetic Refrigeration Materials of La_{0.8}Ce_{0.2}Fe_{11.4}Si_{1.6}B_{α} (α=0, 0.2 and 0.4)

1) The materials were prepared in accordance with the chemical formula La_{0.8}Ce_{0.2}Fe_{11.4}Si_{1.6}B_{α} (α=0, 0.2 and 0.4). The raw materials included La, industrial-pure LaCe alloy (with a purity of 95.91 at. %), Fe, Si and FeB, wherein elementary La was added to make up the La insufficience in the LaCe alloy; B was provided by the FeB alloy; the amount of the elementary Fe added thereto was reduced properly since the FeB alloy contains Fe element, so that the proportion of each element added still met the requirement for the atomic ratio in the chemical formula of the magnetic material.

2) The raw materials prepared in step 1), after mixed, was loaded into an arc furnace. The arc furnace was vacuumized to a pressure of 2×10⁻³ Pa, purged with high-purity argon with a purity of 99.996 wt % twice, and then filled with high-purity argon with a purity of 99.996 wt % to a pressure of 1.5 atm. The arc was struck to generate alloy ingot. Each alloy ingot was smelted repeatedly for 6 times in total, i.e. at a temperature of 1800° C. for 3 times and 2000° C. for 3 times. After the smelting, the ingot alloys were obtained by cooling down in a copper crucible.

3) After wrapped separately with molybdenum foil and sealed in a vacuumized quartz tube (1×10⁻⁴ Pa), the ingot alloy obtained from step 2) was annealed at 1030° C. for 60 days followed by being quenched in liquid nitrogen by breaking the quartz tube. As a result, three La_{0.8}Ce_{0.2}Fe_{11.4}Si_{1.6}B_{α} alloy samples (a were 0, 0.2 and 0.4, respectively) were obtained.

The Performance Test was Conducted Using the Same Method as Those Described in Examples 1 and 2.

I. The X-ray diffraction (XRD) spectrum at room temperature, as shown in FIG. 12, indicated that all three samples in this Example were crystallized into a NaZn₁₃-type structure. The small amount of impurity phases such as α-Fe, etc. detected were labeled with *.

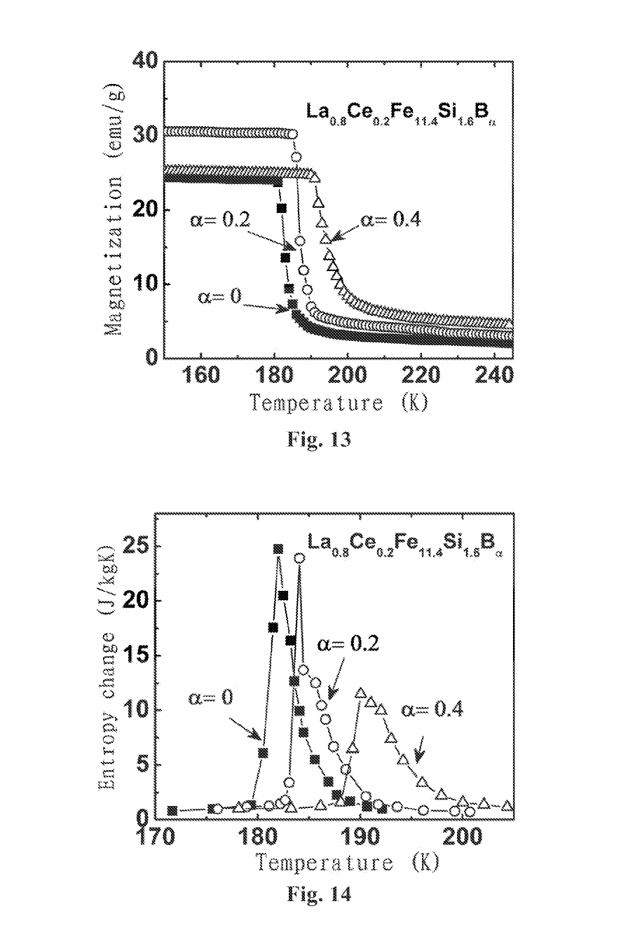

II. FIG. 13 shows the thermomagnetic curves (M-T) of the samples obtained from step 3) in a magnetic field of 0.02 T. It was observed that phase-transition temperatures were 183K (α=0), 187K (α=0.2) and 195K (α=0.4). On the basis of the Maxwell's equation, the magnetic entropy changes were 24.8 J/kgK (α=0), 23.9 J/kgK (α=0.2) and 11.6 J/kgK (α=0.4), respectively while magnetic field changes from 0 to 1 T (FIG. 14).

Conclusion: It can be confirmed in this Example that La(Fe,Si)₁₃-based boride having a NaZn₁₃-type crystal structure was prepared from industrial-pure LaCe alloy as the raw material in accordance with the preparation method described. The presence of impurities in the raw material LaCe alloy had no impact on the formation and growth of the NaZn₁₃ phase. A giant magnetocaloric effect was exhibited; and Curie temperature moved towards the higher temperature zone upon the increase of B content.

### Example 5

### Preparation of Two Magnetic Refrigeration Materials of La_{0.9}Ce_{0.1}(Fe_{0.6}Co_{0.2}Mn_{0.2})_{13-y}Si_{y} (y=0.9 and 1.8)

1) The materials were prepared in accordance with the chemical formula La_{0.9}Ce_{0.1}(Fe_{0.6}Co_{0.2}Mn_{0.2})_{13-y}Si_{y} (y=0.9 and 1.8). The raw materials included industrial-pure LaCe alloy (with a purity of 95.91 at. %), Fe, Si, Co, Mn and La, wherein elementary La was added to make up the La insufficience in the LaCe alloy.

2) The raw materials prepared in step 1), after mixed, was loaded into an arc furnace. The arc furnace was vacuumized to a pressure of 2×10⁻³ Pa, purged with high-purity argon with a purity of 99.6% twice, and then filled with high-purity argon with a purity of 99.6% to a pressure of 0.6 atm. The arc was struck to generate alloy ingot. Each alloy ingot was smelted at a temperature of 2400° C. repeatedly for 5 times. After the smelting, the ingot alloys were obtained by cooling down in a copper crucible.

3) The ingot alloy obtained from step 2) was wrapped separately with molybdenum foil and sealed in a vacuumized quartz tube (1×10⁻⁴ Pa). High-purity argon (99.996 wt %) was filled to 0.2 atm at room temperature (for the purpose of balancing with external pressure after the temperature reached the softening temperature of quartz, so as to prevent deformation of the quartz tube). Then the ingot alloy was annealed at 1300° C. for 3 days. After cooled down to 1100° C., the quartz tube was removed from the furnace and broken in liquid nitrogen, and the ingot alloy was quenched in liquid nitrogen. As a result, two La_{0.9}Ce_{0.1}(Fe_{0.6}Co_{0.2}Mn_{0.2})_{13-y}Si_{y} (y=0.9 and 1.8) alloy samples having a NaZn₁₃-type structure were obtained.

The Performance Test was Conducted Using the Same Method as Those Described in Examples 1 and 2.

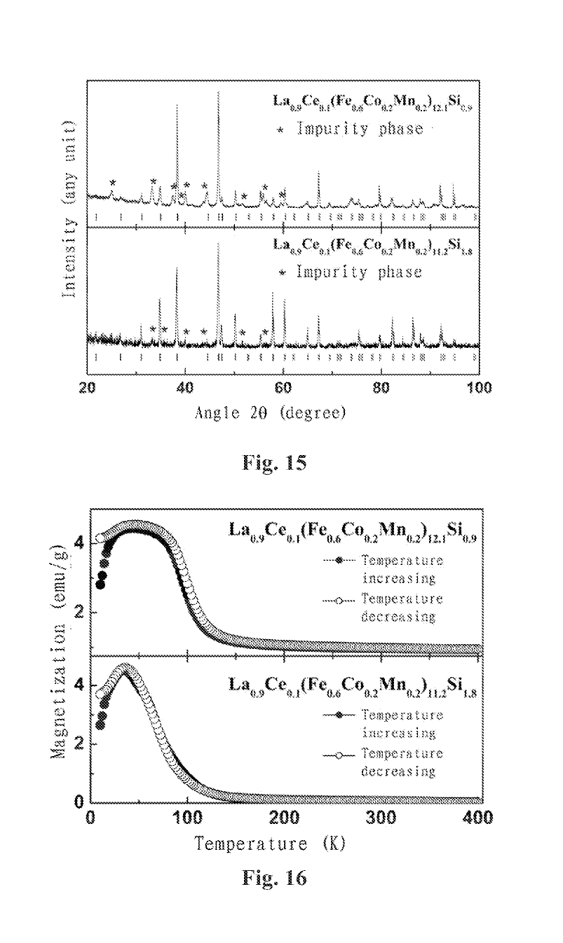

I. The X-ray diffraction (XRD) spectrum of the alloy of this Example, as shown in FIG. 15, indicated that the main phase presented a NaZn₁₃-type structure and a small amount of α-Fe and unknown impurity phase existed (impurity phase was labeled with *).

II. FIG. 16 shows the thermomagnetic curves (M-T) of La_{0.9}Ce_{0.1}(Fe_{0.6}Co_{0.2}Mn_{0.2})_{13-y}Si_{y} (y=0.9 and 1.8) alloy in a magnetic field of 0.02 T. It was observed that phase-transition temperatures were 97K and 70K, respectively. On the basis of the Maxwell's equation, the entropy changes were 1.6 J/kgK and 2.5 J/kgK, respectively while magnetic field changes from 0 to 5 T.

Conclusion: It can be confirmed in this Example in combination with the preceding Examples that La(Fe,Si)₁₃-based magnetocaloric material having a NaZn₁₃-type crystal structure was prepared from industrial-pure LaCe alloy as the raw material in accordance with the preparation method described, in a larger component range (Co content: 0≦p≦0.2, Mn content: 0≦q≦0.2, Si content: 0.8≦y≦2).

### Example 6

### Preparation of Two Magnetic Refrigeration Materials of La_{0.7}Ce_{0.3}Fe_{11.5}Si_{1.5}C_{0.2}H_{0.45} and La_{0.7}Ce_{0.3}Fe_{11.5}Si_{1.5}C_{0.2}B_{0.05}H_{0.55}

1) The materials were prepared in accordance with the chemical formula La_{0.7}Ce_{0.3}Fe_{11.5}Si_{1.5}C_{0.2} and La_{0.7}Ce_{0.3}Fe_{11.5}Si_{1.5}C_{0.2}B_{0.05}H_{0.05}. The raw materials included industrial-pure LaCe alloy (with a purity of 95.91 at. %), FeC, FeB, Si and La, wherein elementary La was added to make up the La insufficience in the mischmetal.

2) The raw materials prepared in step 1), after mixed, was loaded into an arc furnace. The arc furnace was vacuumized to a pressure of 2×10⁻³ Pa, purged with high-purity argon with a purity of 99.996 wt % once, and then filled with high-purity argon with a purity of 99.996 wt. % to a pressure of 1 atm. The arc was struck to generate alloy ingot. Each alloy ingot was smelted at a temperature of 2000° C. repeatedly twice. After the smelting, the ingot alloys were obtained by cooling down in a copper crucible.

3) After wrapped separately with molybdenum foil and sealed in a vacuumized quartz tube (1×10⁻⁴ Pa), the ingot alloy obtained from step 2) was annealed at 1080° C. for 30 days followed by being quenched in liquid nitrogen by breaking the quartz tube. As a result, two alloy samples, La_{0.7}Ce_{0.3}Fe_{11.5}Si_{1.5}C_{0.2} and La_{0.7}Ce_{0.3}Fe_{11.5}Si_{1.5}C_{0.2}B_{0.05} were obtained.

4) The two alloy samples, La_{0.7}Ce_{0.3}Fe_{11.5}Si_{1.5}C_{0.2} and La_{0.7}Ce_{0.3}Fe_{11.5}Si_{1.5}C_{0.2}B_{0.05} obtained from step 3) were crashed separately into alloy particles with a particle size of 0.05˜2 mm.

5) The alloy particles obtained from step 4) were annealed in hydrogen gas using a P-C-T instrument:

a. The La_{0.7}Ce_{0.3}Fe_{11.5}Si_{1.5}C_{0.2} alloy particles obtained from step 4) were placed into the high-pressure sample chamber of a P-C-T instrument. After vacuumized to 1×10⁻¹ Pa and heated to 350° C., the sample chamber was filled with high-purity H₂ (purity: 99.99%). The H₂ pressure was adjusted to 0.101, 0.205, 0.318, 0.411, 0.523, 0.617, 0.824, 1.014 MPa respectively, and under each pressure, the hydrogen absorption was maintained for 1 min. Then the high-pressure sample chamber was placed into water at room temperature (20° C.), so as to be cooled down to room temperature. As calculated on the basis of the P-C-T analysis and weighing, it was determined that H content was about 0.45 and a magnetic refrigeration material, i.e. La_{0.7}Ce_{0.3}Fe_{11.5}Si_{1.5}C_{0.2}H_{0.45} hydride was obtained.

b. The La_{0.7}Ce_{0.3}Fe_{11.5}Si_{1.5}C_{0.2}B_{0.05} alloy particles obtained from step 4) were placed into the high-pressure sample chamber of a P-C-T instrument. After vacuumized to 1×10⁻¹ Pa and heated to 200° C., the sample chamber was filled with high-purity H₂ (purity: 99.99%). The H₂ pressure was adjusted to 0.0125, 0.0543, 0.115, 0.168, 0.218, 0.274, 0.326, 0.419 MPa respectively, and the hydrogen absorption was maintained for 1 min under each of the first 7 pressures and for 3 days under the last pressure. Then the high-pressure sample chamber was placed into water at room temperature (20° C.), so as to be cooled down to room temperature. As calculated on the basis of the P-C-T analysis and weighing, it was determined that H content was about 0.55 and a magnetic refrigeration material, i.e. La_{0.7}Ce_{0.3}Fe_{11.5}Si_{1.5}C_{0.2}B_{0.05}H_{0.55} hydride was obtained.

The Performance Test was Conducted Using the Same Method as Those Described in Examples 1 and 2.

I. The X-ray diffraction (XRD) spectrum of the two hydride materials in this Example shows that the two hydride materials are of a NaZn₁₃-type.

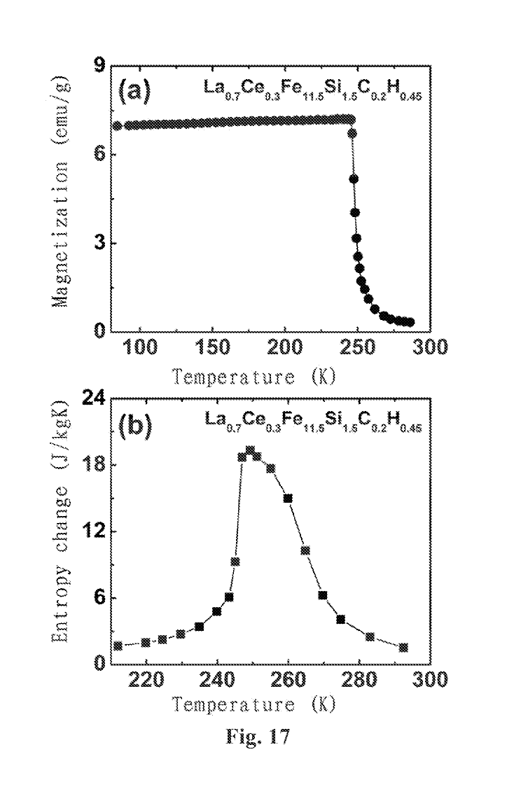

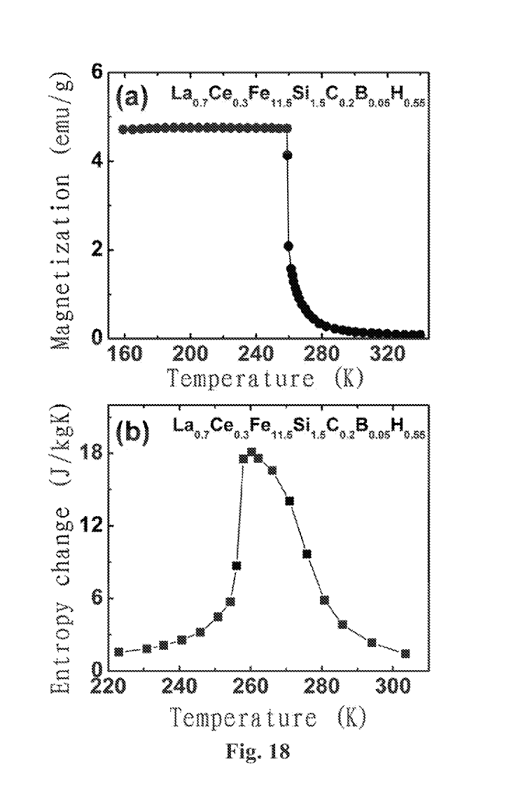

II. FIGS. 17a, b and FIGS. 18a, b show the thermomagnetic curves (M-T) of the two materials in a magnetic field of 0.02 T and the dependency of the magnetic entropy change (ΔS) calculated according to Maxwell's equation on temperature (calculation of ΔS in the process of increasing the field). It was observed that for the two hydride materials, i.e. La_{0.7}Ce_{0.3}Fe_{11.5}Si_{1.5}C_{0.2}H_{0.45} and La_{0.7}Ce_{0.3}Fe_{11.5}Si_{1.5}C_{0.2}B_{0.05}H_{0.55}, the phase-transition temperatures were ˜248K and ˜259K, respectively; the maximal magnetic entropy change (ΔS) were about 19.3 J/kgK and 18.1 J/kgK, respectively while magnetic field changes from 0 to 5 T; and the magnetocaloric effect range was considerable large.

Conclusion: The multiple interstitial carbon/boron/hydrogen compound obtained by annealing in hydrogen atmosphere, the La(Fe,Si)₁₃-based carbide/carbon-boron compound prepared from industrial-pure LaCe alloy as the raw material exhibited considerable magnetocaloric effect. By regulating and controlling the hydrogen absorption process, the phase-transition temperature of the material can be adjusted to move towards the higher temperature zone. As a result, the material has a great magnetic entropy change at a high temperature, which plays an important role in magnetic refrigerating application in practice.

### Example 7

### Preparation of the Magnetic Refrigeration Materials of La_{0.7}Ce_{0.21}(Pr_{0.25}Nd_{0.75})_{0.09}Fe_{11.6}Si_{1.4}

1) The materials were prepared in accordance with the chemical formula La_{0.7}Ce_{0.21}(Pr_{0.25}Nd_{0.75})_{0.09}Fe_{11.6}Si_{1.4}. The raw materials included industrial-pure LaCe alloy (with a purity of 95.91 at. %), Fe, Si, La, Pr, and Nd.

2) The raw materials prepared in step i), after mixed, was loaded into an arc furnace. The arc furnace was vacuumized to a pressure of 2×10⁻³ Pa, purged with high-purity argon with a purity of 99.996 wt % twice, and then filled with high-purity argon with a purity of 99.996 wt. % to a pressure of 1 atm. The arc was struck to generate alloy ingot. Each alloy ingot was smelted at a temperature of 2000° C. repeatedly for 4 times. After the smelting, the ingot alloys were obtained by cooling down in a copper crucible.

3) After wrapped separately with molybdenum foil and sealed in a vacuumized quartz tube (1×10⁻⁴ Pa), the ingot alloy obtained from step 2) was annealed at 1080° C. for 30 days followed by being quenched in liquid nitrogen by breaking the quartz tube. As a result, sample La_{0.7}Ce_{0.21}(Pr_{0.25}Nd_{0.75})_{0.09}Fe_{11.6}Si_{1.4} having a NaZn₁₃-type structure was obtained.

The Performance Test was Conducted Using the Same Method as Those Described in Examples 1 and 2.

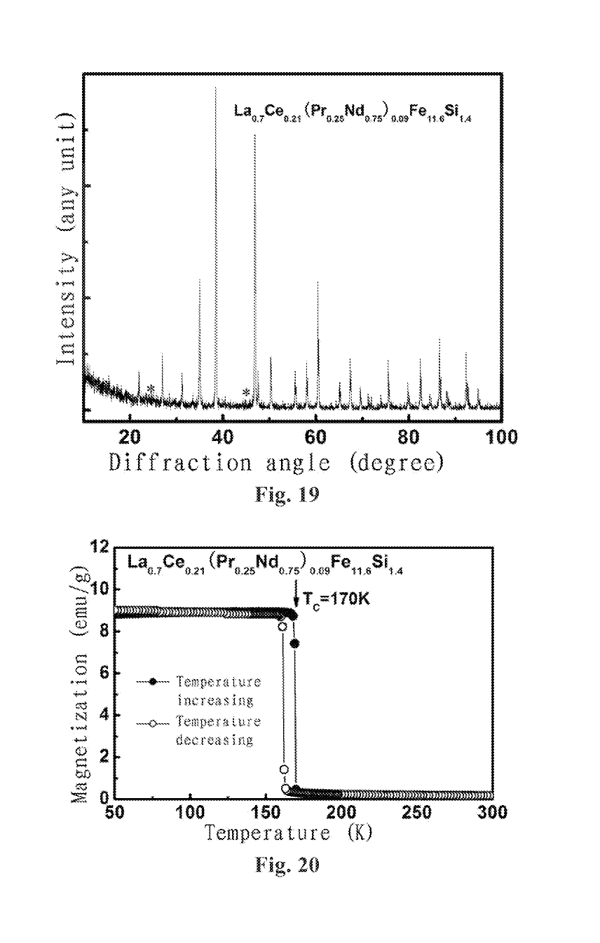

I. The X-ray diffraction (XRD) spectrum of the alloy of this Example, as shown in FIG. 19, indicated that the main phase of sample La_{0.7}Ce_{0.21}(Pr_{0.25}Nd_{0.75})_{0.09}Fe_{11.6}Si_{1.4} presented a NaZn₁₃-type structure and a small amount of unknown impurity phases (labeled with * in FIG. 19) existed.

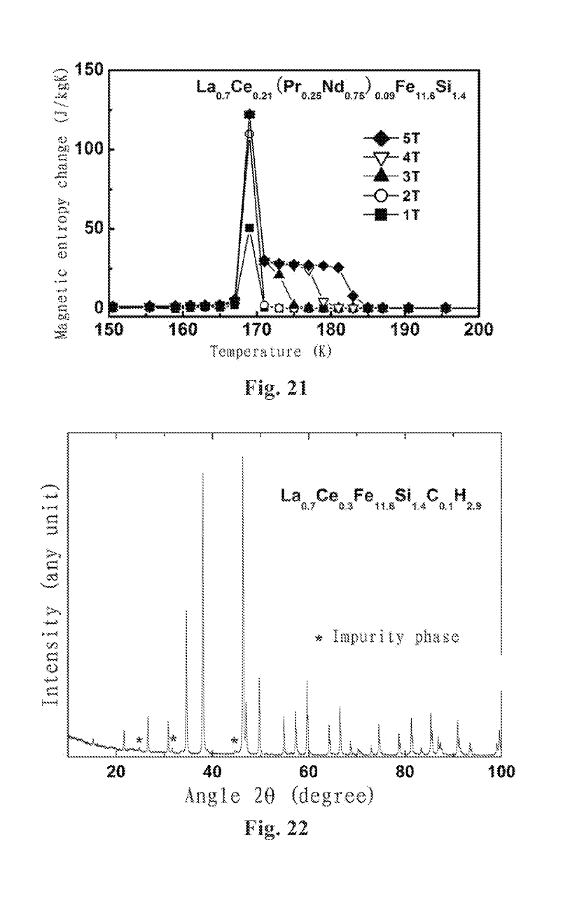

II. The thermomagnetic curves (M-T) in a magnetic field of 0.02 T, as shown in FIG. 10 indicated that Curie temperature (T_{C}) of the sample was 170K and the temperature hysteresis ΔT was about 8K. The magnetization curves (M-H curves) were measured at different temperatures in the process of increasing the field; and the magnetic entropy change ΔS calculated on the basis of Maxwell's equation was shown in FIG. 21. It was found that while magnetic field changes from 0 to 5 T, the effective magnetic entropy change (ΔS plateau) was 29.8 J/kgK; and the full widths at half maximum was 14.8K. A high and wide plateau of magnetic entropy change is particularly required by Ericsson-type magnetic refrigerators, which plays an important role in magnetic refrigerating application in practice.

Conclusion: It can be confirmed in this Example that La(Fe,Si)₁₃-based carbide having a NaZn₁₃-type crystal structure was prepared from industrial-pure LaCe alloy as the raw material in accordance with the preparation method described. The presence of impurities in the raw material LaCe alloy had no impact on the formation and growth of the NaZn₁₃ phase. The replacement of La with Ce, Pr, Nd introduced together enabled the hysteresis to be extended, which indicated the increase of the first-order phase-transition property and in turn, the enhancement of the effective magnetic entropy change.

### Example 8

### Preparation of the Magnetic Refrigeration Materials of La_{0.7}Ce_{0.3}Fe_{11.6}Si_{1.4}C_{0.1}H_{2.9}

1) The materials were prepared in accordance with the chemical formula La_{0.7}Ce_{0.3}Fe_{11.6}Si_{1.4}C_{0.1}. The raw materials included industrial-pure LaCe alloy (95.91 at. %), La, FeC, Fe and Si.

2) The raw materials prepared in step 1), after mixed, was loaded into an arc furnace. The arc furnace was vacuumized to a pressure of 2×10⁻³ Pa, purged with high-purity argon with a purity of 99.996 wt % twice, and then filled with high-purity argon with a purity of 99.996 wt. % to a pressure of 1.4 atm. The arc was struck to generate alloy ingot. Each alloy ingot was smelted at a temperature of 2000° C. repeatedly for twice. After the smelting, the ingot alloys were obtained by cooling down in a copper crucible.

3) After wrapped separately with molybdenum foil and sealed in a vacuumized quartz tube (1×10⁻⁴ Pa), the ingot alloy obtained from step 2) was annealed at 1100° C. for 10 days followed by being quenched in liquid nitrogen by breaking the quartz tube. As a result, La_{0.7}Ce_{0.3}Fe_{11.6}Si_{1.4}C_{0.1} alloy material was obtained.

4) The La_{0.7}Ce_{0.3}Fe_{11.6}Si_{1.4}C_{0.1} alloy material obtained from step 3) was crashed separately into irregular particles with an average size of 20˜200 micron.

5) The La_{0.7}Ce_{0.3}Fe_{11.6}Si_{1.4}C_{0.1} alloy particles obtained from step 4) were annealed in hydrogen gas using a P-C-T instrument: the La_{0.7}Ce_{0.3}Fe_{11.6}Si_{1.4}C_{0.1} irregular alloy particles were placed into the high-pressure sample chamber of a P-C-T instrument. After vacuumized to 1×10⁻¹ Pa and heated to 120° C., the sample chamber was filled with high-purity H₂ (purity: 99.99%). The H₂ pressure was adjusted to 1×10⁻⁵, 2×10⁻³, 0.1015, 1.579, 2.083, 3.054, 4.128, 5.142, 6.190, 7.083, 8.120, 9.653 MPa (1 atm≈0.101325 MPa) respectively, and the hydrogen absorption was maintained for 25 min under each of the first 11 pressures and for 3 days under the last pressure. Then the high-pressure sample chamber was placed into water at room temperature (20° C.), so as to be cooled down to room temperature. As calculated on the basis of the P-C-T analysis and weighing, it was determined that H content was about 2.9 and a magnetic refrigeration material, i.e. La_{0.7}Ce_{0.3}Fe_{11.6}Si_{1.4}C_{0.1}H_{2.9} hydride was obtained.

The Performance Test was Conducted Using the Same Method as Those Described in Examples 1 and 2.

I. The X-ray diffraction (XRD) spectrum at room temperature, as shown in FIG. 22, indicated that the main phase of sample presented a NaZn₁₃-type structure and a small amount of impurity phases (labeled with *) existed.

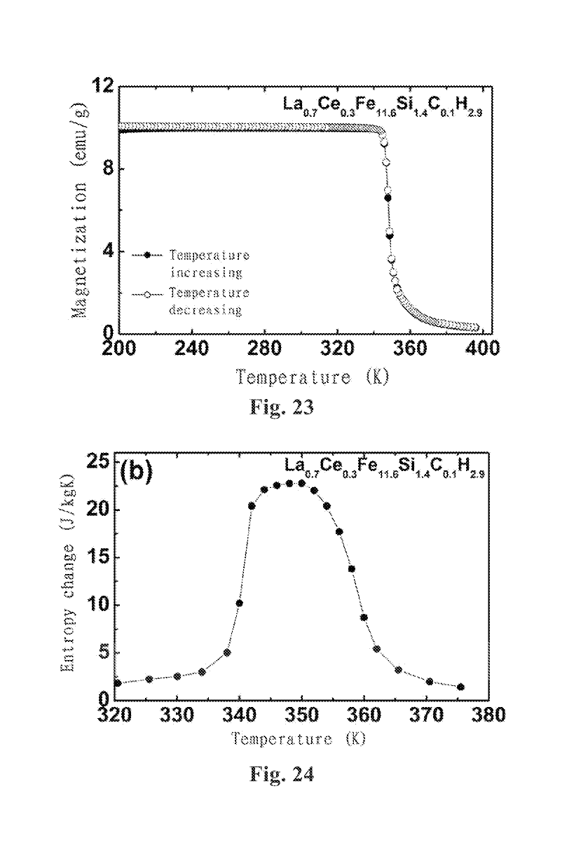

II. FIG. 23 and FIG. 24 show the thermomagnetic (M-T) curves in a magnetic field of 0.02 T and the dependency of the magnetic entropy change (ΔS) calculated according to Maxwell's equation on temperature (calculation of ΔS in the process of increasing the field). It was observed that for the La_{0.7}Ce_{0.3}Fe_{11.6}Si_{1.4}C_{0.1}H_{2.9} hydride material, the phase-transition temperature was ˜348K; the maximal magnetic entropy change (ΔS) was 22.8 J/kgK while magnetic field changes from 0 to 5 T; and the magnetocaloric effect range was significant.

Conclusion: The multiple interstitial carbon/hydrogen compound obtained by annealing, in hydrogen atmosphere, the La(Fe,Si)₁₃-based carbide prepared from industrial-pure LaCe alloy as the raw material exhibited considerable magnetocaloric effect. By regulating and controlling the hydrogen absorption process, the amount of absorbed hydrogen can be adjusted and the phase-transition temperature moved towards the higher temperature zone. As a result, the material has a great magnetic entropy change at a high temperature, which plays an important role in magnetic refrigerating application in practice.

### Example 9

### Preparation of Three Magnetic Refrigeration Materials of La_{0.7}(Ce,Pr,Nd)_{0.3}Fe_{11.5}Si_{1.4}C_{y} (y=0, 0.1 and 0.2)

1) The materials were prepared in accordance with the chemical formula La_{0.7}(Ce,Pr,Nd)_{0.3}Fe_{11.6}Si_{1.4}C_{y} (y=0, 0.1 and 0.2). The raw materials included industrial-pure La—Ce—Pr—Nd mischmetal (with a purity of 99.6 wt %), elementary Fe, elementary Si, elementary La and FeC alloy, wherein elementary La was added to make up the La insufficience in the mischmetal; C was provided by the FeC alloy; the amount of the elementary Fe added thereto was reduced properly since the FeC alloy contains Fe element, so that the proportion of each element added still met the requirement for the atomic ratio in the chemical formula of the magnetic material.

2) The raw materials prepared in step 1), after mixed, was loaded into an arc furnace. The arc furnace was vacuumized to a pressure of 2×10⁻³ Pa, purged with high-purity argon with a purity of 99.996 wt % twice, and then filled with high-purity argon with a purity of 99.996 wt. % to a pressure of 1 atm. The arc was struck to generate alloy ingot. Each alloy ingot was smelted at a temperature of 2000° C. repeatedly for 4 times. After the smelting, the ingot alloys were obtained by cooling down in a copper crucible.

3) After wrapped separately with molybdenum foil and sealed in a vacuumized quartz tube (1×10⁻⁴ Pa), the ingot alloy obtained from step 2) was annealed at 1080° C. for 30 days followed by being quenched in liquid nitrogen by breaking the quartz tube. As a result, samples La_{0.7}(Ce,Pr,Nd)_{0.3}Fe_{11.6}Si_{1.4}C_{y} (y=0, 0.1, 0.2) having a NaZn₁₃-type structure were obtained.

Performance Test

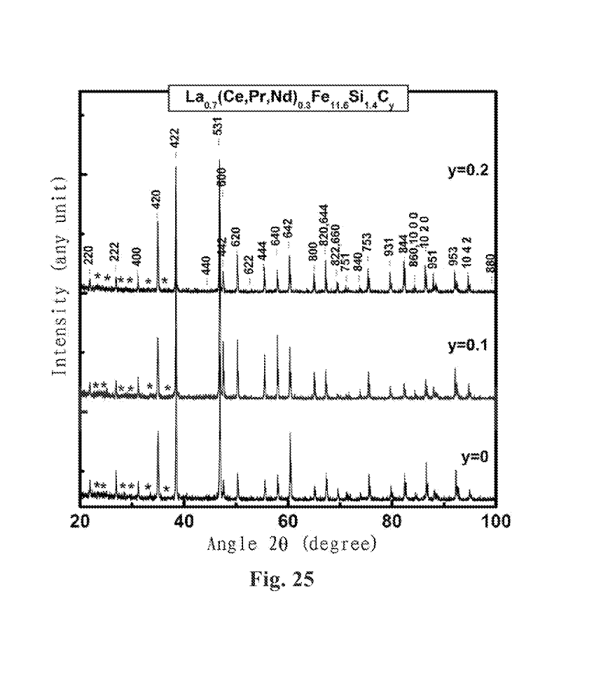

I. The X-ray diffraction (XRD) spectrum of the samples at room temperature was measured using the Cu-target X-ray diffractometer. The result, as shown in FIG. 25, indicated that samples La_{0.7}(Ce,Pr,Nd)_{0.3}Fe_{11.6}Si_{1.4}C_{y} (y=0, 0.1, 0.2) all presented a clean NaZn₁₃-type singe-phase structure. α-Fe impurity phase, commonly exists in such systems especially a system containing C, was not detected, meaning that the presence of impurities in the raw material high-Ce and industrial-pure mischmetal La—Ce—Pr—Nd had no impact on the formation and growth of the NaZn₁₃ phase. The correlation between the small amount of impurities detected (peaks labeled with * in FIG. 25) and the existence of impurities in the raw material high-Ce mischmetal needs to be further confirmed. The small amount of unknown impurities coexisted with NaZn₁₃-type main phase, but the presence of impurity phase had no impact on the formation and growth of the NaZn₁₃-type main phase.

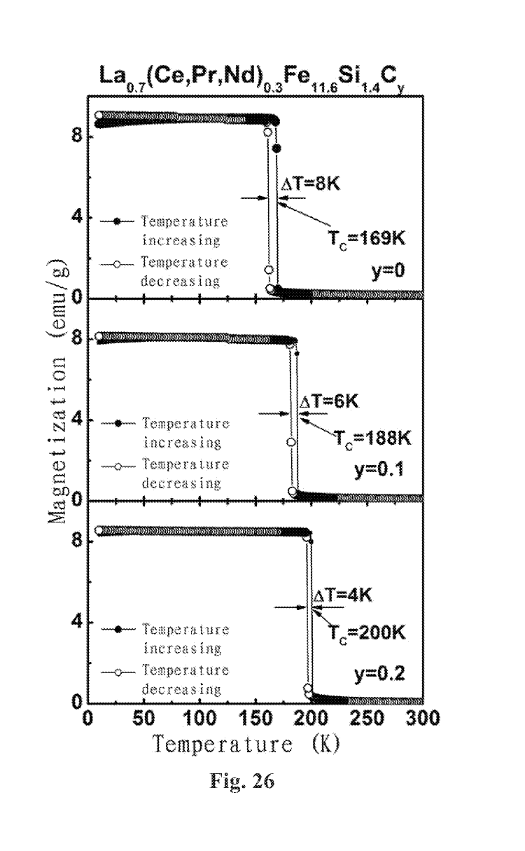

II. The thermomagnetic curves (M-T) of samples La_{0.7}(Ce,Pr,Nd)_{0.3}Fe_{11.6}Si_{1.4}C_{y} (y=0, 0.1, 0.2) were measured in a magnetic field of 0.02 T, using the Superconducting Quantum Interference Vibrating Sample Magnetometer (MPMS (SQUID) VSM). As shown in FIG. 26, it can be determined Curie temperature (T_{C}) was raised from 169K (y=0) to 200K (y=0.2) while C content was increased; and the temperature hysteresis ΔT was reduced from 8K (y=0) to 4K (y=0.2).

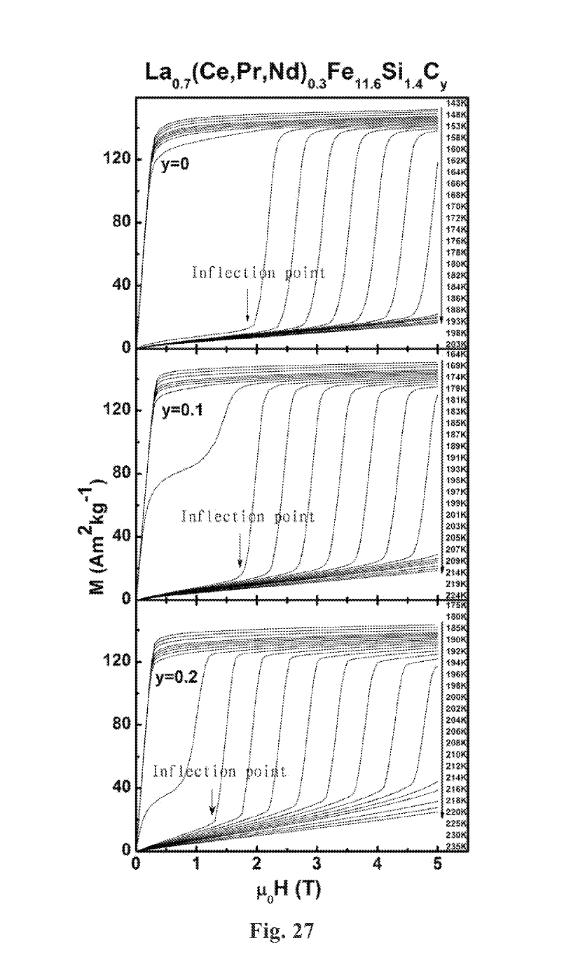

The magnetization curves (M-H curves) of samples La_{0.7}(Ce,Pr,Nd)_{0.3}Fe_{11.6}Si_{1.4}C (y=0, 0.1, 0.2) were measured on the MPMS (SQUID) VSM at different temperatures in the process of increasing the field, as shown in FIG. 27. The presence of an inflection point in the MH curve indicated that metamagnetic transition from paramagnetic to ferromagnetic state was induced by the magnetic field, meaning that the presence of impurities in the high-Ce and industrial-pure mischmetal LaCrPrNd had no impact on the formation of the 1:13 phase or the presence of metamagnetic transition behaviour, so that a giant magnetocaloric effect was ensured for the materials.

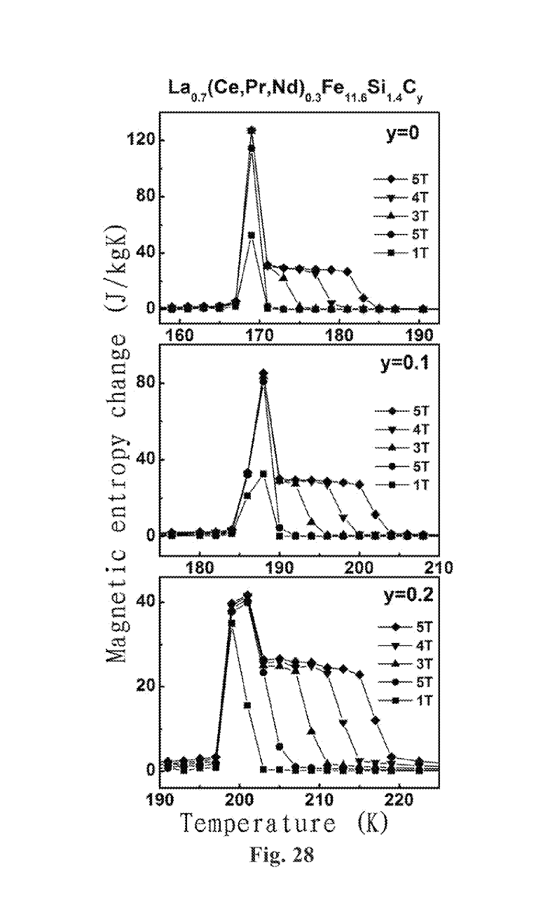

On the basis of the Maxwell's equation, the magnetic entropy change, ΔS, was calculated according to the isothermal magnetization curve. FIG. 28 shows the dependency of ΔS on temperature for La_{0.7}(Ce,Pr,Nd)_{0.3}Fe_{11.6}Si_{1.4}C_{y} (y=0, 0.1, 0.2) in different magnetic fields. From FIG. 28, it was observed that the ΔS peak shape extended asymmetrically towards the high-temperature zone while the field was increased; the sharp peak was followed by a plateau, which is a typical feature of a La(Fe,Si)₁₃-based first-order phase transition system and caused by the metamagnetic transition induced by the magnetic field at a temperature higher than Curie temperature. The ΔS peak shape further confirmed the existence of the first-order phase-transition property and metamagnetic transition behaviour of the system, which in turn indicated that the presence of impurities in the high-Ce and industrial-pure mischmetal LaCrPrNd had no impact on the formation of the 1:13 phase or the presence of metamagnetic transition behaviour, so that a giant magnetocaloric effect was ensured for the materials. It has been demonstrated by some studies that the appearance of the ΔS peak caused by the coexistence of two phases during the first-order phase transition is a false signal; the plateau reflects the essential property of magnetocaloric effect. For samples y=0, 0.1, 0.2, the ΔS plateau were 31.6 J/kgK, 30.2 J/kgK and 26.6 J/kgK while the magnetic field change was 0 to 5 T, all significantly higher than the magnetic entropy change of the traditional magnetic refrigeration material Gd at room temperature (the magnetic entropy change was 9.8 J/kgK in a magnetic field of 5 T); the full widths at half maximum were 14.4K, 16.6K and 18.9K; and refrigeration capacities were 404.6 J/kg, 467.9 J/kg and 461.7 J/kg, respectively. A high and wide plateau of magnetic entropy change is particularly required by Ericsson-type magnetic refrigerators, which plays an important role in magnetic refrigerating application in practice.

Conclusion: It can be confirmed by this Example that La(Fe,Si)₁₃-based carbide having a NaZn₁₃-type crystal structure was prepared from high-Ce and industrial-pure mischmetal as the raw material in accordance with the preparation method described; the presence of impurities in the high-Ce and industrial-pure mischmetal material had no impact on the formation and growth of the NaZn₃ phase; metamagnetic transition behaviour was maintained; a giant magnetocaloric effect was exhibited; Curie temperature moved towards higher temperature zone while C content was increased.

### Example 10

### Preparation of Five Magnetic Refrigeration Materials of La_{0.7}(Ce,Pr,Nd)_{0.3}(Fe₁₋ₓCoₓ)_{11.6}Si_{1.4} (x=0.02, 0.04, 0.06, 0.08 and 0.1)

1) The materials were prepared in accordance with the chemical formula La_{0.7}(Ce,Pr,Nd)_{0.3}(Fe₁₋ₓCoₓ)_{11.6}Si_{1.4} (x=0.02, 0.04, 0.06, 0.08 and 0.1). The raw materials included industrial-pure La—Ce—Pr—Nd mischmetal (with a purity of 99.6 wt %), elementary Fe, elementary Co, elementary Si and elementary La, wherein elementary La was used to make up the La insufficience in the mischmetal.

2) The raw materials prepared in step 1), after mixed, was loaded into an arc furnace. The arc furnace was vacuumized to a pressure of 2×10⁻³ Pa, purged with high-purity argon with a purity of 99.996 wt % twice, and then filled with high-purity argon with a purity of 99.996 wt. % to a pressure of 1 atm. The arc was struck to generate alloy ingot. Each alloy ingot was smelted at a temperature of 2000° C. repeatedly for 4 times. After the smelting, the ingot alloys were obtained by cooling down in a copper crucible.

3) After wrapped separately with molybdenum foil and sealed in a vacuumized quartz tube (1×10⁻⁴ Pa), the ingot alloy obtained from step 2) was annealed at 1080° C. for 30 days followed by being quenched in liquid nitrogen by breaking the quartz tube. As a result, samples La_{0.7}(Ce, Pr, Nd)_{0.3}(Fe₁₋ₓCoₓ)_{11.6}Si_{1.4} (x=0.02, 0.04, 0.06, 0.08, 0.1) having a NaZn₁₃-type structure were obtained.

Performance Test

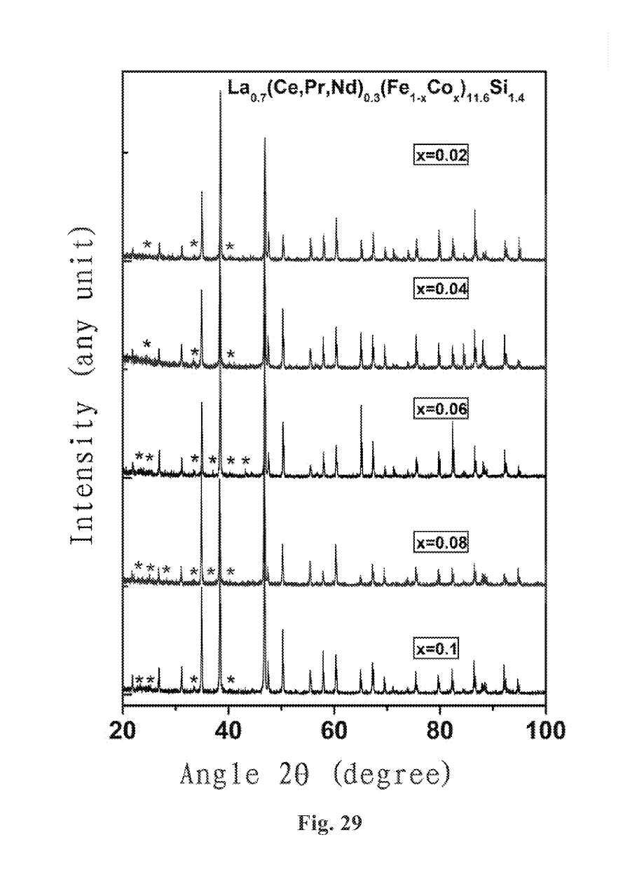

I. The X-ray diffraction (XRD) spectrum of the samples at room temperature was measured using the Cu-target X-ray diffractometer. The result, as shown in FIG. 29, indicated that all three samples La_{0.7}(Ce,Pr,Nd)_{0.3}(Fe₁₋ₓCoₓ)_{11.6}Si_{1.4} (x=0.02, 0.04, 0.06, 0.08, 0.1) had a main phase with a NaZn₁₃-type structure. α-Fe impurity phase, commonly exists in such systems, was not detected in any of these five samples containing different amounts of Co. The correlation between the small amount of unknown impurity phases detected (peaks labeled with * in FIG. 29) and the existence of impurities in the raw material i.e. high-Ce mischmetal needs to be further confirmed. The small amount of unknown impurity phases coexisted with NaZn₁₃-type main phase, but the presence of impurity phases had no impact on the formation and growth of the NaZn₁₃-type main phase.

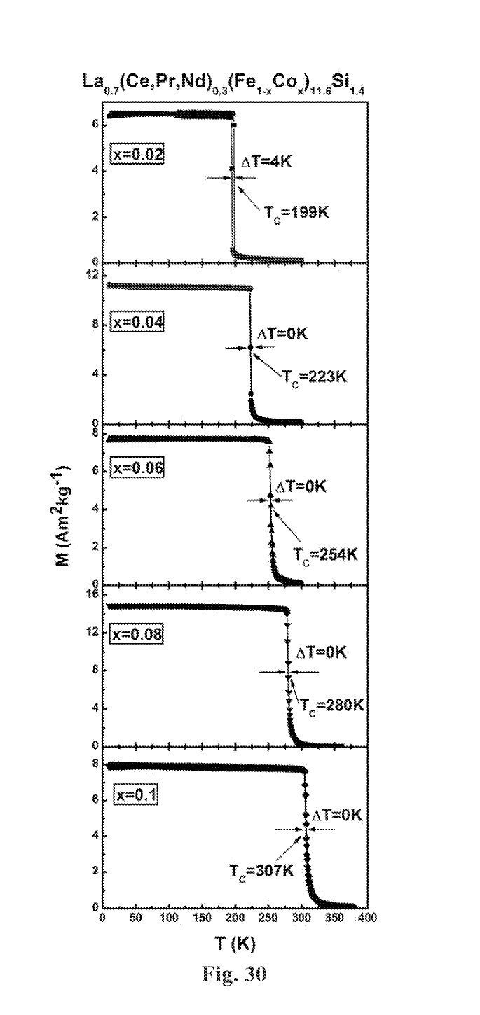

II. The thermomagnetic curves (M-T) of samples La_{0.7}(Ce,Pr,Nd)_{0.3}(Fe₁₋ₓCoₓ)_{11.6}Si_{1.4} (x=0.02, 0.04, 0.06, 0.08, 0.1) were measured in a magnetic field of 0.02 T, using the Superconducting Quantum Interference Vibrating Sample Magnetometer (MPMS (SQUID) VSM). As shown in FIG. 30, it can be determined that Curie temperature (T_{C}) was raised from 198K (x=0.02) to 306K (x=0.1) while Co content was increased; and the temperature hysteresis was reduced from 4K to 0 while Co content was increased from x=0.02 to x=0.06.

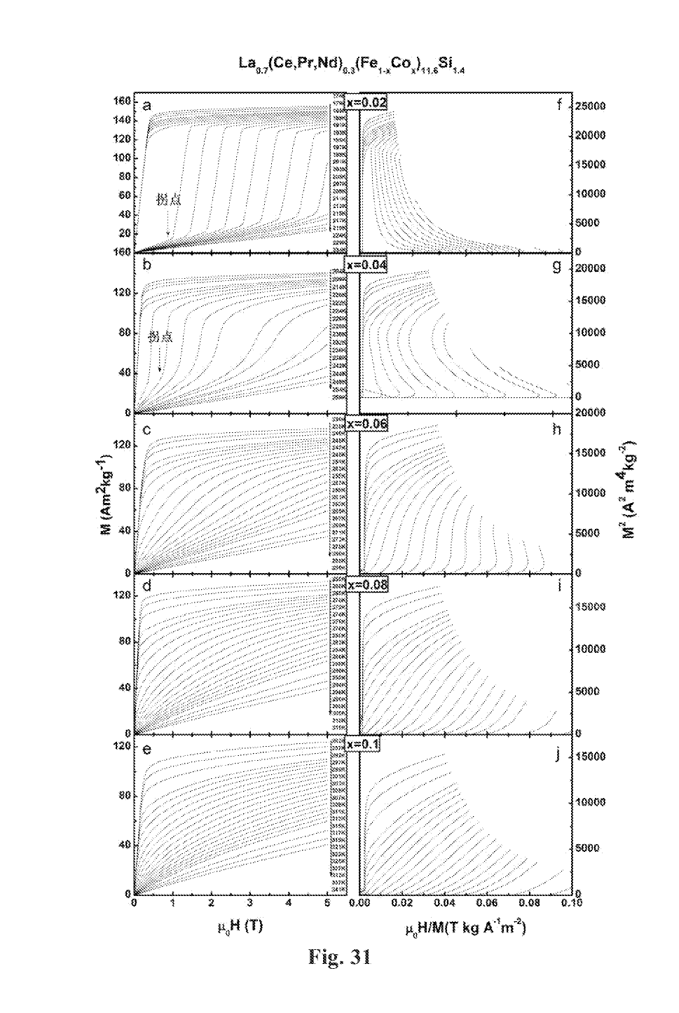

The magnetization curves (M-H curves) of samples La_{0.7}(Ce,Pr,Nd)_{0.3}(Fe₁₋ₓCoₓ)_{11.6}Si_{1.4} (x=0.02, 0.04, 0.06, 0.08, 0.1) were measured on the MPMS (SQUID) VSM at different temperatures in the process of increasing the field, as shown in FIG. 31. The presence of an inflection point in the M-H curve (FIGS. 31a, b, c, d, e) (or the inflection point or negative slope in the Arrott diagram (FIGS. 31f, g, h, i, j)) indicated that metamagnetic transition from paramagnetic to ferromagnetic state was induced by the magnetic field, meaning that the presence of impurities in the industrial-pure and high-Ce mischmetal La—Ce—Pr—Nd raw material had no impact on the formation of the 1:13 phase or the presence of metamagnetic transition behaviour, so that a giant magnetocaloric effect was ensured for the materials. In addition, while the Co content was reduced, the metamagnetic transition behaviour was weakened and the inflection point disappeared.

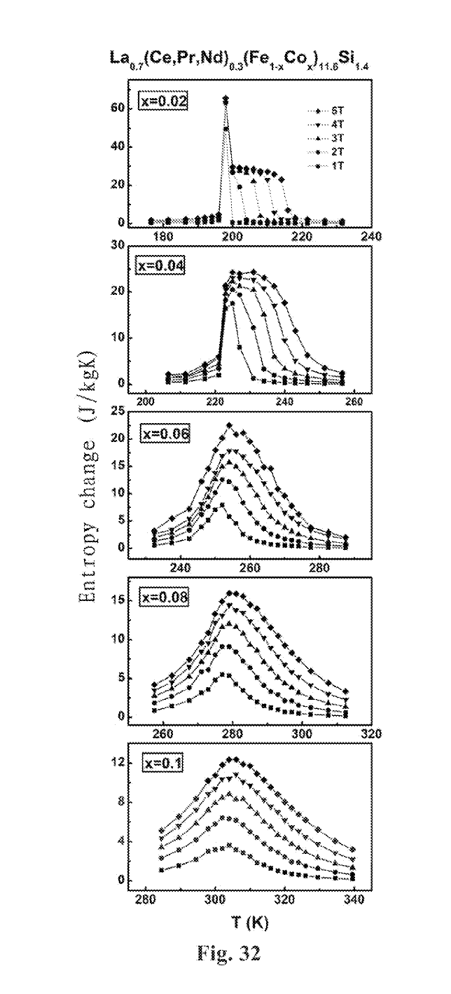

On the basis of the Maxwell's equation, the magnetic entropy change, ΔS, can be calculated according to the isothermal magnetization curve. FIG. 32 shows the dependency of ΔS on temperature for samples La_{0.7}(Ce,Pr,Nd)_{0.3}(Fe₁₋ₓCoₓ)_{11.6}Si_{1.4} (x=0.02, 0.04, 0.06, 0.08, 0.1) in different magnetic fields. From FIG. 32, it was observed that the ΔS peak shape extended asymmetrically towards the high-temperature zone while the field was increased and the metamagnetic transition from paramagnetic to ferromagnetic state was induced by the magnetic field at a temperature higher than Curie temperature, which demonstrates the presence of metamagnetic transition behaviour in the system. Upon the increase of the Co content, metamagnetic transition behaviour was weakened and the ΔS peak shape tended to become symmetric gradually. The asymmetrical extension of the ΔS peak shape further demonstrated that the presence of impurities in the industrial-pure and high-Ce mischmetal La—Ce—Pr—Nd raw material had no impact on the formation of the 1:13 phase or the presence of metamagnetic transition behaviour, so that a giant magnetocaloric effect was ensured for the materials. For the five samples x=0.02, 0.04, 0.06, 0.08, 0.1, the ΔS peak values were 29.6 J/kgK, 24.3 J/kgK, 22.5 J/kgK, 16.0 J/kgK, 12.4 J/kgK while the magnetic field change was 0 to 5 T, all higher than the magnetic entropy change of the traditional magnetic refrigeration material Gd at room temperature (the magnetic entropy change was 9.8 J/kgK in a magnetic field of 5 T) at 198K, 225K, 254K, 279K, 306K; the full widths at half maximum were 18.2K, 20.9K, 22.5K, 29.3K, 37.7K; and refrigeration capacities were 491.6 J/kg, 446.9 J/kg, 396.8 J/kg, 363.9 J/kg, 359.6 J/kg, respectively.

Conclusion: It can be confirmed in this Example that La(Fe,Si)₁₃-based compound having a NaZn₃-type crystal structure was prepared from industrial-pure LaCe alloy as the raw material in accordance with the preparation method described, wherein the replacement of Fe with Co enabled Curie temperature to raise up to around room temperature. The presence of impurities in the raw material LaCe alloy had no impact on the formation and growth of the NaZn₁₃ phase; and a giant magnetocaloric effect was exhibited.

Compared with the LaFeSi-based material prepared from LaCe alloy as the raw material, the second-order phase-transition LaFeSi-based material prepared from La—Ce—Pr—Nd mischmetal as the raw material showed greater magnetocaloric effect around room temperature. For example, in a magnetic field of 5 T, the second-order phase-transition systems La_{0.7}(Ce,Pr,Nd)_{0.3}(Fe₁₋ₓCoₓ)_{11.6}Si_{1.4}, x=0.06, 0.08 prepared from La—Ce—Pr—Nd mischmetal as the raw material had magnetic entropy change peaks of 22.5 J/kgK (254K) and 16.0 J/kgK (279K), refrigeration capacities of 396.8 J/kg and 363.9 J/k, respectively; whereas the second-order phase-transition systems La_{0.7}Ce_{0.3}(Fe_{1-y}Co_{y})_{11.6}Si_{1.4}, y=0.06, 0.08 prepared from LaCe alloy as the raw material and having similar composition had magnetic entropy change peaks of 18.2 J/kgK (251K) and 14.1 J/kgK (279K), refrigeration capacities of 350.8 J/kg and 340.3 J/kg, respectively. The former systems had higher magnetic entropy changes (24% and 13% higher, respectively) and refrigeration capacities (13% and 7% higher, respectively), compared with the latter systems, which is due to the competition of various exchange couplings such as R—R, R-T.

Conclusion: It can be confirmed by this Example that La(Fe,Si)₁₃-based compound having a NaZn₁₃-type crystal structure was prepared from high-Ce and industrial-pure mischmetal as the raw material in accordance with the preparation method described; the presence of impurities in the high-Ce and industrial-pure mischmetal material had no impact on the formation and growth of the NaZn₁₃ phase; the replacement of Fe with Co raised Curie temperature to around room temperature. Compared with the material prepared from LaCe alloy as the raw material, such La(Fe,Si)₁₃-based compound showed a higher giant magnetocaloric effect in room temperature zone.

### Example 11

### Preparation of La_{0.7}(Ce,Pr,Nd)_{0.3}Fe_{11.6}Si_{1.4}H_{1.6} hydride Magnetic Refrigeration Material

1) The materials were prepared in accordance with the chemical formula La_{0.7}(Ce,Pr,Nd)_{0.3}Fe_{11.6}Si_{1.4}. The raw materials included industrial-pure La—Ce—Pr—Nd mischmetal (with a purity of 99.6 wt %), elementary Fe, elementary Si and elementary La, wherein elementary La was used to make up the La insufficience in the mischmetal.

2) The raw materials prepared in step 1), after mixed, was loaded into an arc furnace. The arc furnace was vacuumized to a pressure of 2×10⁻³ Pa, purged with high-purity argon with a purity of 99.996 wt % twice, and then filled with high-purity argon with a purity of 99.996 wt. % to a pressure of 1 atm. The arc was struck to generate alloy ingot. Each alloy ingot was smelted at a temperature of 2000° C. repeatedly for 4 times. After the smelting, the ingot alloys were obtained by cooling down in a copper crucible.

3) After wrapped separately with molybdenum foil and sealed in a vacuumized quartz tube (1×10⁻⁴ Pa), the ingot alloy obtained from step 2) was annealed at 1080° C. for 30 days followed by being quenched in liquid nitrogen by breaking the quartz tube. As a result, sample La_{0.7}(Ce,Pr,Nd)_{0.3}Fe_{11.6}Si_{1.4} having a NaZn₁₃-type structure was obtained.

4) The La_{0.7}(Ce,Pr,Nd)_{0.3}Fe_{11.6}Si_{1.4} sample was crashed and screened, then irregular particles with a particle size of 0.5-2 mm were obtained.

5) The La_{0.7}(Ce,Pr,Nd)_{0.3}Fe_{11.6}Si_{1.4} particles were subjected to heat treatment in hydrogen gas using a P-C-T instrument: the La_{0.7}(Ce,Pr,Nd)_{0.3}Fe_{11.6}Si_{1.4} irregular particles were placed into the high-pressure sample chamber of a P-C-T instrument. After vacuumized to 1×10⁻¹ Pa and heated to 250° C., the sample chamber was filled with high-purity H₂ (purity: 99.99%). The H₂ pressure was adjusted to 0.1081, 0.1847, 0.2463, 0.2909, 0.3407, 0.3938, 0.4450, 0.5492, 0.5989 MPa (1 atm=0.101325 MPa) respectively, and the hydrogen absorption was maintained for 3-10 min under each pressure. Then the high-pressure sample chamber was placed into water at room temperature (20° C.), so as to be cooled down to room temperature. As calculated on the basis of the P-C-T analysis and weighing, it was determined that a magnetic refrigeration material, i.e. La_{0.7}(Ce, Pr, Nd)_{0.3}Fe_{11.6}Si_{1.4}H_{1.6} hydride with H content of about 1.6 was obtained.

Performance Test

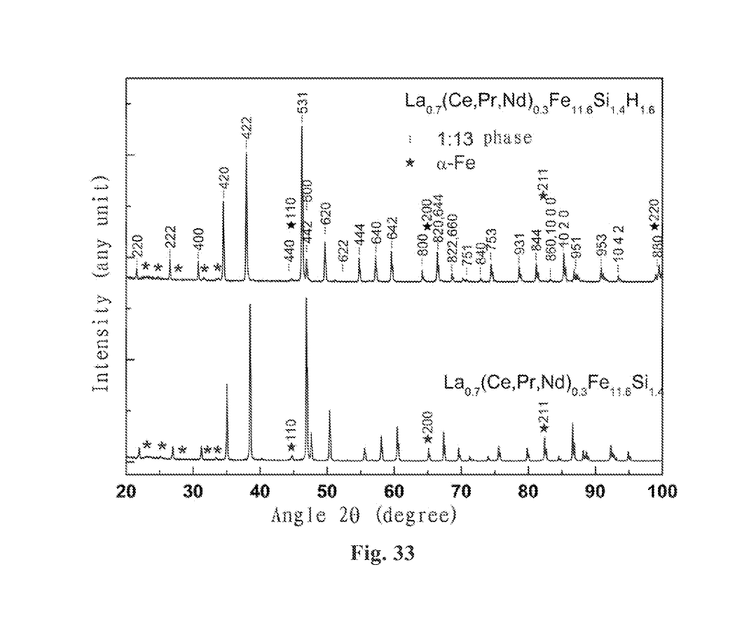

I. The X-ray diffraction (XRD) spectrum of La_{0.7}(Ce, Pr, Nd)_{0.3}Fe_{11.6}Si_{1.4}H_{1.6} hydride at room temperature was measured using the Cu-target X-ray diffractometer before and after hydrogen absorption. The result, as shown in FIG. 33, indicated that sample La_{0.7}(Ce,Pr,Nd)_{0.3}Fe_{11.6}Si_{1.4}H_{1.6} hydride had a main phase with a NaZn₁₃-type structure both before and after hydrogen absorption. Due to the introduction of interstitial H atoms, the cell parameter was increased from 11.452 Å (before hydrogen absorption) to 11.576 Å (after hydrogen absorption). A small amount of unknown impurity phases were detected both before and after hydrogen absorption (the peaks labeled as * in FIG. 33). The correlation between the unknown impurity phases and the existence of impurities in the raw material i.e. high-Ce mischmetal needs to be further confirmed. The small amount of unknown impurity phases coexisted with NaZn₁₃-type main phase, but the presence of impurity phases had no impact on the formation and growth of the NaZn₁₃-type main phase.

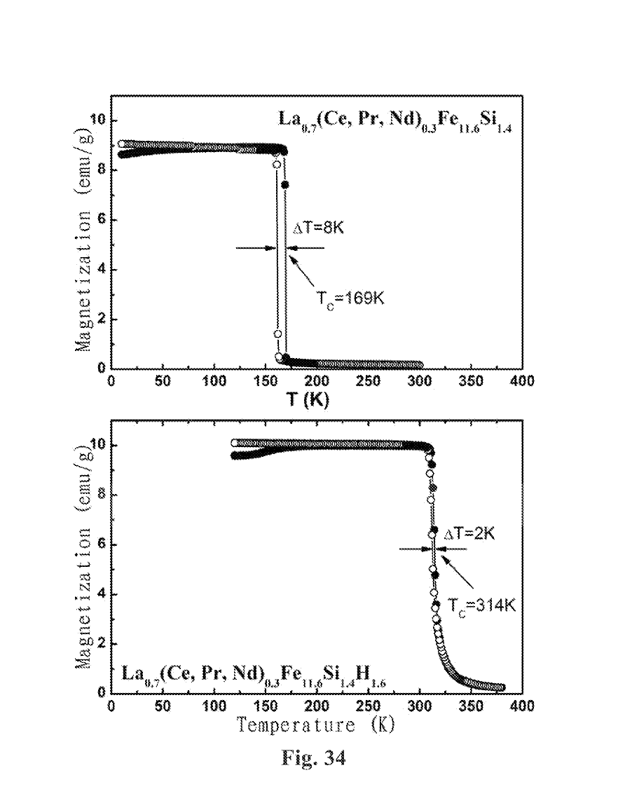

II. The thermomagnetic curves (M-T) of sample La_{0.7}(Ce,Pr,Nd)_{0.3}Fe_{11.6}Si_{1.4}H_{1.6} were measured in a magnetic field of 0.02 T, before and after hydrogen absorption, using the Superconducting Quantum Interference Vibrating Sample Magnetometer (MPMS (SQUID) VSM). As shown in FIG. 34, it can be determined that Curie temperature (T_{C}) was raised from 169K (before hydrogen absorption) to 314K (after hydrogen absorption); and the temperature hysteresis was reduced from 8K (before hydrogen absorption) to 2K (after hydrogen absorption).

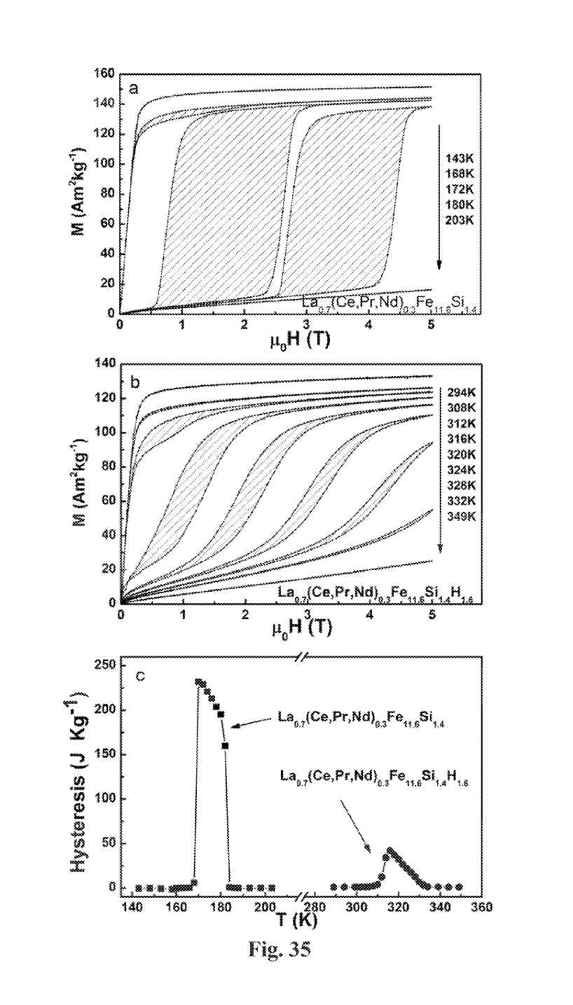

The magnetization curves (M-H curves) of sample La_{0.7}(Ce,Pr,Nd)_{0.3}Fe_{11.6}Si_{1.4}H_{1.6} were measured on the MPMS (SQUID) VSM at different temperatures, in the process of increasing and decreasing the field, before and after hydrogen absorption, as shown in FIGS. 35a, b. FIG. 35c shows the correlation between magnetic hysteresis loss and temperature, before and after hydrogen absorption, respectively. It can be determined that after hydrogen absorption, the Curie temperature was dramatically raised to room temperature; both temperature hysteresis and magnetic hysteresis were reduced significantly; and the maximal magnetic hysteresis was lowered from about 232 J/kg (before hydrogen absorption) to about 42 J/kg (after hydrogen absorption).

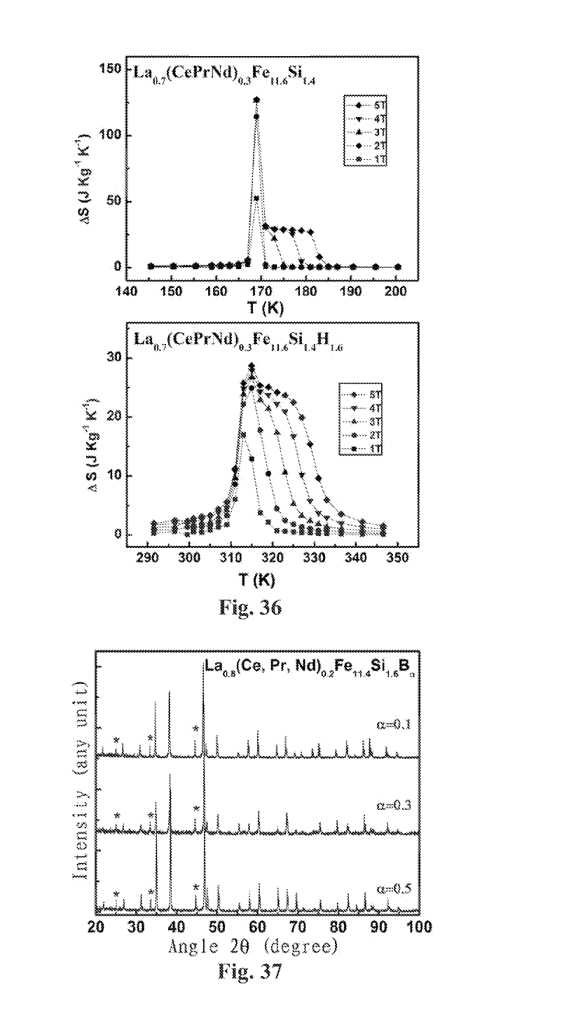

On the basis of the Maxwell's equation, the magnetic entropy change, ΔS, can be calculated according to the isothermal magnetization curve. FIG. 36 shows the dependency of ΔS on temperature for sample La_{0.7}(Ce,Pr,Nd)_{0.3}Fe_{11.6}Si_{1.4}H_{1.6} before and after hydrogen absorption, in different magnetic fields. After hydrogen absorption, the Curie temperature was dramatically raised to room temperature. Although the effective magnetic entropy change peak value (magnetic entropy change plateau) was slightly reduced from 32.5 J/kgK (before hydrogen absorption) to 27.8 J/kgK (after hydrogen absorption) in a magnetic field of 5 T, the magnetic entropy change peak value before and after hydrogen absorption were both higher than the magnetic entropy change of the traditional magnetic refrigeration material Gd at room temperature (the magnetic entropy change was 9.8 J/kgK in a magnetic field of 5 T). After taking out the maximal magnetic hysteresis loss, the effective refrigeration capacity was increased from 152 J/kg (before hydrogen absorption) to 378 J/kg J/kgK (after hydrogen absorption), i.e. increased by about 150%. Both the giant magnetocaloric effect and robust refrigeration capacity play important roles in magnetic refrigerating application in practice.

Conclusion: the hybride obtained by annealing the La(Fe,Si)₁₃-based compound prepared from high-Ce and industrial-pure mischmetal as the ras material in hydrogen gas showed a considerable magnetocaloric effect. By adjusting and controlling the hydrogen absorption process, the phase-transition temperature was raised, the hysteresis loss was reduced and the effective refrigeration capacity was increased, so that the material showed a predominant magnetocaloric effect in the high temperature and even room temperature zones, which is very important for magnetic refrigerating application in practice.

### Example 12

### Preparation of Three Magnetic Refrigeration Materials of La_{0.8}(Ce,Pr,Nd)_{0.2}Fe_{11.4}Si_{1.6}B_{α} (α=0.1, 0.3 and 0.5)

1) The materials were prepared in accordance with the chemical formula La_{0.8}(Ce,Pr,Nd)_{0.2}Fe_{11.4}Si_{1.6}B_{α} (α=0.1, 0.3 and 0.5). The raw materials included industrial-pure La—Ce—Pr—Nd mischmetal (with a purity of 98.4 wt %), elementary La, elementary Fe, elementary Si and FeB alloy.

2) The raw materials prepared in step 1), after mixed, was loaded into an arc furnace. The arc furnace was vacuumized to a pressure of 2×10⁻³ Pa, purged with high-purity argon with a purity of 99.996 wt % twice, and then filled with high-purity argon with a purity of 99.996 wt. % to a pressure of 1.4 atm. The arc was struck to generate alloy ingot. Each alloy ingot was smelted at a temperature of 1800° C., 2000° C., 2200° C. or 2500° C. repeatedly for 4 times. After the smelting, the ingot alloys were obtained by cooling down in a copper crucible.

3) After wrapped separately with molybdenum foil and sealed in a vacuumized quartz tube (1×10⁻⁴ Pa) separately, the ingot alloy obtained from step 2) was annealed at 1030° C. for 60 days followed by being quenched in liquid nitrogen by breaking the quartz tube. As a result, three alloy sample La_{0.8}(Ce, Pr, Nd)_{0.2}Fe_{11.4}Si_{1.6}B_{α} (α=0.1, 0.3 and 0.5) (α=0, 0.1, 0.3 and 0.5, respectively) was obtained.

The Performance Test was Conducted Using the Same Method as Those Described in Examples 1 and 2.

I. The X-ray diffraction (XRD) spectrum of the alloy materials in the Example at room temperature, as shown in FIG. 37, indicated that the alloy was crystallized into a NaZn₁₃-type structure and a small amount of impurity phase such as α-Fe, etc. (peaks labeled with * in the Figure) existed. The small amount of unknown impurity phases coexisted with NaZn₁₃-type main phase, but the presence of impurity phases had no impact on the formation and growth of the NaZn₁₃-type main phase.

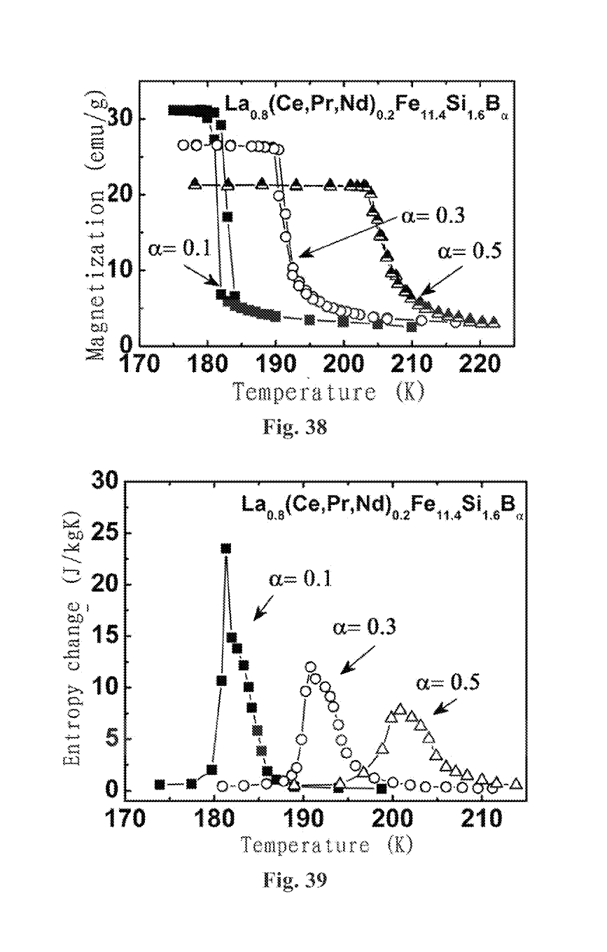

II. FIG. 38 shows the thermomagnetic curves (M-T) of the alloy materials in a magnetic field of 0.02 T. It can be determined that the phase-transition temperature were 183K (α=0.1), 192K (α=0.3) and 206K (α=0.5), respectively. On the basis of the Maxwell's equation, it was calculated that the magnetic entropy change of the three alloy samples were 23.5 J/kgK (α=0.1), 12.0 J/kgK (α=0.3) and 7.8 J/kgK (α=0.5), respectively while magnetic field changes from 0 to 1 T (as shown in FIG. 39).

Conclusion: It can be confirmed by this Example that La(Fe,Si)₁₃-based boride having a NaZn₁₃-type crystal structure was prepared from high-Ce and industrial-pure mischmetal as the raw material in accordance with the preparation method described; the presence of impurities in the high-Ce and industrial-pure mischmetal material had no impact on the formation and growth of the NaZn₁₃ phase; the system showed a giant magnetocaloric effect; and Curie temperature was raised towards the higher temperature while B content was increased.

### Example 13

### Preparation of La_{0.7}(Ce,Pr,Nd)_{0.3}Fe_{11.6}Si_{1.4}C_{0.1}H_{2.8} Magnetic Refrigeration Material

1) The materials were prepared in accordance with the chemical formula La_{0.7}(Ce,Pr,Nd)_{0.3}Fe_{11.6}Si_{1.4}C_{0.1}. The raw materials included industrial-pure La—Ce—Pr—Nd mischmetal (with a purity of 98.4 wt %), La, FeC, Fe and Si.

2) The raw materials prepared in step 1), after mixed, was loaded into an arc furnace. The arc furnace was vacuumized to a pressure of 2×10⁻³ Pa, purged with high-purity argon with a purity of 99.996 wt % twice, and then filled with high-purity argon with a purity of 99.996 wt. % to a pressure of 1.4 atm. The arc was struck to generate alloy ingot. Each alloy ingot was smelted at a temperature of 2000° C. repeatedly for 6 times. After the smelting, the ingot alloys were obtained by cooling down in a copper crucible.

3) After wrapped separately with molybdenum foil and sealed in a vacuumized quartz tube (1×10⁻⁴ Pa), the ingot alloy obtained from step 2) was annealed at 1100° C. for 10 days followed by being quenched in liquid nitrogen by breaking the quartz tube. As a result, La_{0.7}(Ce,Pr,Nd)_{0.3}Fe_{11.6}Si_{1.4}C_{0.1} alloy material was obtained.

4) The La_{0.7}(Ce,Pr,Nd)_{0.3}Fe_{11.6}Si_{1.4}C_{0.1} material obtained in step 3) was crashed into irregular particles with a particle size of 0.05˜2 mm.

5) The La_{0.7}(Ce,Pr,Nd)_{0.3}Fe_{11.6}Si_{1.4}C_{0.1} alloy particles obtained from step 4) were annealed in hydrogen gas using a P-C-T instrument: the La_{0.7}(Ce,Pr,Nd)_{0.3}Fe_{11.6}Si_{1.4}C_{0.1} irregular alloy particles were placed into the high-pressure sample chamber of a P-C-T instrument. After vacuumized to 1×10⁻¹ Pa and heated to 120° C., the sample chamber was filled with high-purity H₂ (purity: 99.99%). The H₂ pressure was adjusted to 1×10⁻⁵, 2×10⁻³, 0.1017, 1.505, 2.079, 3.013, 4.182, 5.121, 6.076, 7.102, 8.074, 9.683 MPa (1 atm≈0.101325 MPa) respectively, and the hydrogen absorption was maintained for 25 min under each of the first 11 pressures and for 3 days under the last pressure. Then the high-pressure sample chamber was placed into water at room temperature (20° C.), so as to be cooled down to room temperature. As calculated on the basis of the P-C-T analysis and weighing, it was determined that H content was about 2.8 and a magnetic refrigeration material, i.e. La_{0.7}(Ce,Pr,Nd)_{0.3}Fe_{11.6}Si_{1.4}C_{0.1}H_{2.8} hydride was obtained.

The Performance Test was Conducted Using the Same Method as Those Described in Examples 1 and 2.

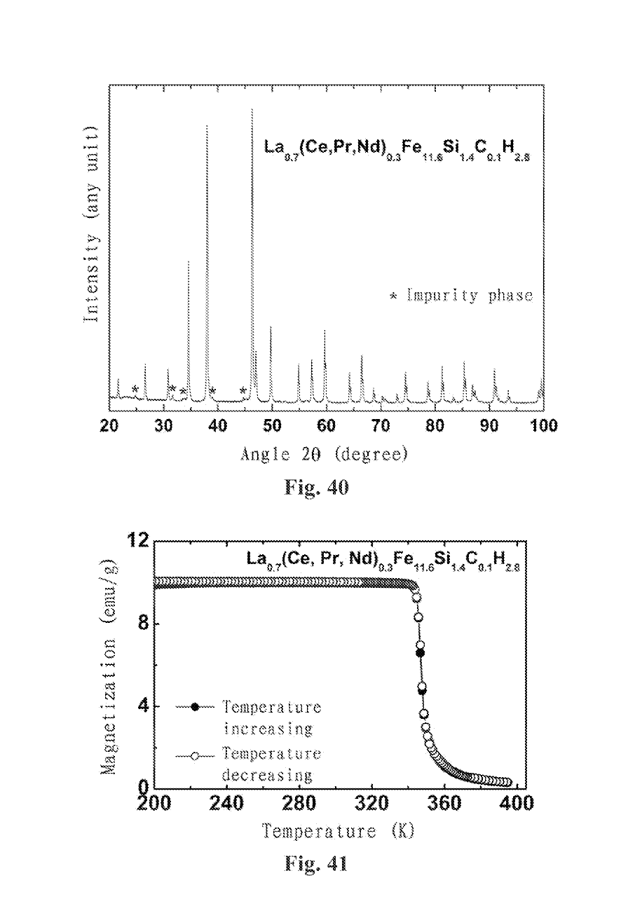

I. The X-ray diffraction (XRD) spectrum at room temperature, as shown in FIG. 40, indicated that the main phase presented a NaZn₁₃-type structure; and a small amount of impurity phases existed (as labeled with *).

II. FIG. 41 and FIG. 42 show the thermomagnetic curves (M-T) in a magnetic field of 0.02 T and the dependency of the magnetic entropy change ΔS calculated according to Maxwell's equation on temperature (calculation of ΔS in the process of increasing the field). It was found that La_{0.7}(Ce,Pr,Nd)_{0.3}Fe_{11.6}Si_{1.4}C_{0.1}H_{2.8} hydride material had a phase-transition temperature of ˜347K; maximal magnetic entropy change of 23.6 J/kgK while the field was increased from 0 to 5 T and a considerable magnetocaloric effect.

Conclusion: The multiple interstitial carbon/hydrogen compound obtained by annealing, in hydrogen atmosphere, the La(Fe,Si)₁₃-based carbide prepared from industrial-pure La—Ce—Pr—Nd alloy as the raw material exhibited a considerable magnetocaloric effect. By regulating and controlling the hydrogen absorption process, the amount of hydrogen absorption can be adjusted; the phase-transition temperature can be moved towards the higher temperature zone. As a result, the material had a great magnetic entropy change at a high temperature, which plays an important role in magnetic refrigerating application in practice.

### Example 14

### Preparation of Two Magnetic Refrigeration Materials of La_{0.9}(Ce,Pr,Nd)_{0.1}(Fe_{0.6}Co_{0.2}Mn_{0.2})_{13-y}Si_{y} (V=0.9 and 1.8)

1) The materials were prepared in accordance with the chemical formula La_{0.9}(Ce,Pr,Nd)_{0.1}(Fe_{0.6}Co_{0.2}Mn_{0.2})_{13-y}Si_{y} (y=0.9 and 1.8). The raw materials included industrial-pure La—Ce—Pr—Nd mischmetal (with a purity of 98.4 wt %), Fe, Si, Co, Mn and La.

2) The raw materials prepared in step 1), after mixed, was loaded into an arc furnace. The arc furnace was vacuumized to a pressure of 2×10⁻³ Pa, purged with high-purity argon with a purity of 99.6% twice, and then filled with high-purity argon with a purity of 99.6% to a pressure of 0.6 atm. The arc was struck to generate alloy ingot. Each alloy ingot was smelted at a temperature of 2400° C. repeatedly for 5 times. After the smelting, the ingot alloys were obtained by cooling down in a copper crucible.

3) The ingot alloy obtained from step 2) was wrapped separately with molybdenum foil and sealed in a vacuumized quartz tube (1×10⁻⁴ Pa). High-purity argon (99.996 wt %) was filled to 0.2 atm at room temperature (for the purpose of balancing with external pressure after the temperature reached the softening temperature of quartz, so as to prevent deformation of the quartz tube). Then the ingot alloy was annealed at 1380° C. for 2 hours. After cooled down to 1100° C., the quartz tube was removed from the furnace and broken in liquid nitrogen, and the ingot alloy was quenched in liquid nitrogen. As a result, two-component alloy La_{0.9}(Ce,Pr,Nd)_{0.1}(Fe_{0.6}Co_{0.2}Mn_{0.2})_{13-y}Si_{y} (y=0.9 and 1.8) was obtained.

The Performance Test was Conducted Using the Same Method as Those Described in Examples 1 and 2.

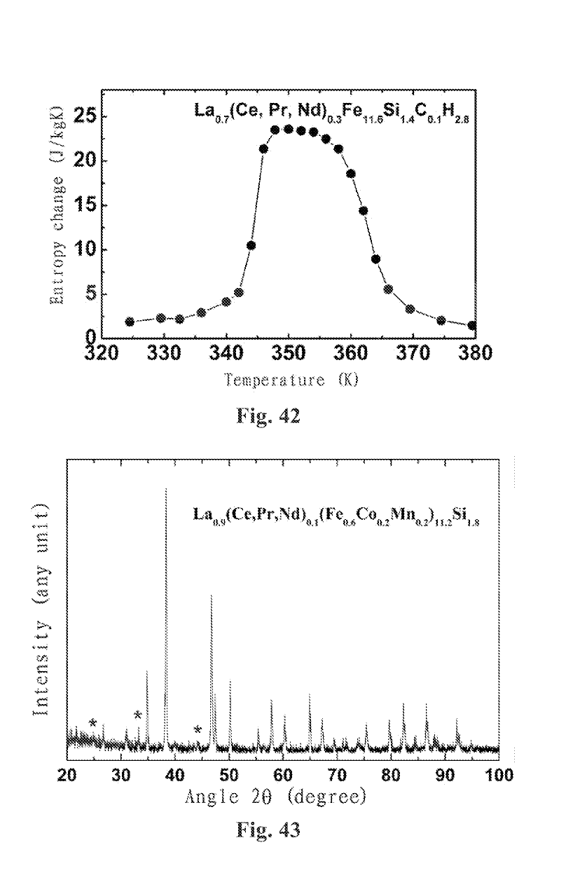

I. The X-ray diffraction (XRD) spectrum at room temperature indicated that the main phase of both materials presented NaZn₁₃-type structures; and α-Fe and unknown impurity phase existed. FIG. 43 shows the X-ray diffraction (XRD) spectrum at room temperature of La_{0.9}Ce_{0.1}(Fe_{0.6}Co_{0.2}Mn_{0.2})_{13-y}Si_{y} (y=1.8) alloy particles, wherein the impurity phases are labeled with *).

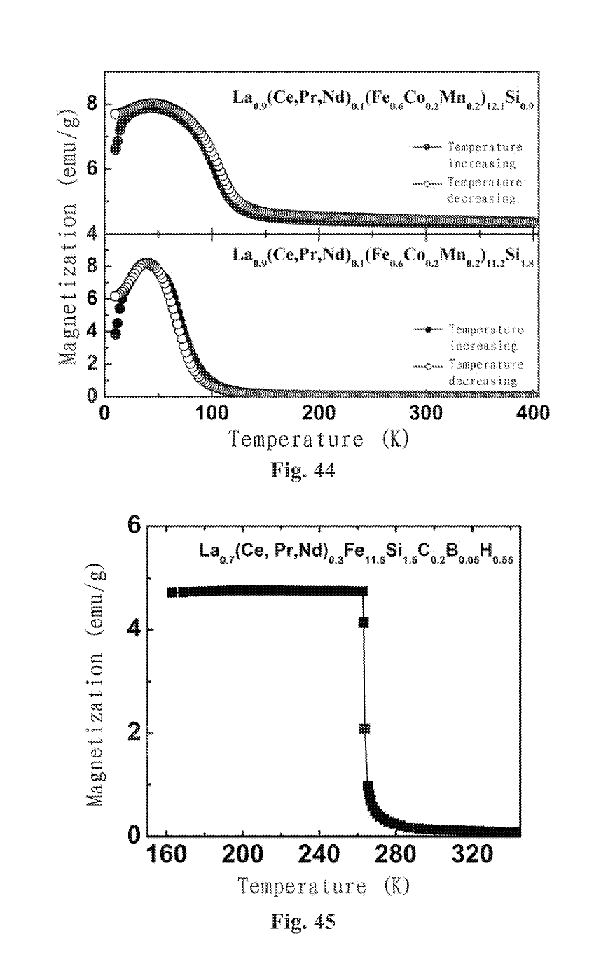

II. FIG. 44 shows the thermomagnetic curves (M-T) of La_{0.9}(Ce,Pr,Nd)_{0.1}(Fe_{0.6}Co_{0.2}Mn_{0.2})_{13-y}Si_{y} (y—0.9 and 1.8) alloy sample in a magnetic field of 0.02 T. It can be determined that the two materials had phase-transition temperatures of 102K and 71K and calculated entropy changes of 1.4 J/kgK and 2.3 J/kgK while the field was increased from 0 to 5 T, respectively.

Conclusion: It can be confirmed by this Example in combination with Example 10 that La(Fe,Si)₁₃-based magnetocaloric material having a NaZn₁₃-type structure was prepared from industrial-pure La—Ce—Pr—Nd mischmetal as the raw material in accordance with the preparation method described, in a larger component range (Co content: 0≦p≦0.2, Mn content: 0≦q≦0.2, Si content: 0.8<y≦1.8).

### Example 15

### Preparation of La_{0.7}(Ce,Pr,Nd)_{0.3}Fe_{11.4}Si_{1.5}C_{0.2}B_{0.05}H_{0.55} Multiple Interstitial Magnetic Refrigeration Material

1) The materials were prepared in accordance with the chemical formula La_{0.7}(Ce,Pr,Nd)_{0.3}Fe_{11.5}Si_{1.5}C_{0.2}B_{0.05}. The raw materials included industrial-pure La—Ce—Pr—Nd mischmetal (with a purity of 98.4 wt %), FeC, FeB, Fe, Si and La.

2) The raw materials prepared in step 1), after mixed, was loaded into an arc furnace. The arc furnace was vacuumized to a pressure of 2×10⁻³ Pa, purged with high-purity argon with a purity of 99.996 wt % once, and then filled with high-purity argon with a purity of 99.996 wt % to a pressure of 1 atm. The arc was struck to generate alloy ingot. Each alloy ingot was smelted at a temperature of 2000° C. repeatedly twice. After the smelting, the ingot alloys were obtained by cooling down in a copper crucible.

3) After wrapped separately with molybdenum foil and sealed in a vacuumized quartz tube (1×10⁻⁴ Pa), the ingot alloy obtained from step 2) was annealed at 1080° C. for 30 days followed by being quenched in liquid nitrogen by breaking the quartz tube. As a result, La_{0.7}(Ce,Pr,Nd)_{0.3}Fe_{11.5}Si_{1.5}C_{0.2}B_{0.05} alloy was obtained.

4) The La_{0.7}(Ce,Pr,Nd)_{0.3}Fe_{11.5}Si_{1.5}C_{0.2}B_{0.05} alloy obtained in step 3) was cut into alloy particles with a particle size of 0.05-2 mm.

5) The alloy particles obtained from step 4) were annealed in hydrogen gas using a P-C-T instrument: the La_{0.7}(Ce,Pr,Nd)_{0.3}Fe_{11.5}Si_{1.5}C_{0.2}B_{0.05} alloy particles were placed into the high-pressure sample chamber of a P-C-T instrument. After vacuumized to 1×10⁻¹ Pa and heated to 350° C., the sample chamber was filled with high-purity H₂ (purity: 99.99%). The H₂ pressure was adjusted to 0.0113, 0.0508, 0.116, 0.164, 0.205, 0.262, 0.410, 0.608, 0.874 MPa (1 atm≈0.101325 MPa) respectively, and the hydrogen absorption was maintained for 1 min under each of the first 8 pressures and for 3 days under the last pressure. Then the high-pressure sample chamber was placed into water at room temperature (20° C.), so as to be cooled down to room temperature. As calculated on the basis of the P-C-T analysis and weighing, it was determined that H content was about 0.55 and a magnetic refrigeration material, i.e. La_{0.7}(Ce,Pr,Nd)_{0.3}Fe_{11.5}Si_{1.5}C_{0.2}B_{0.05}H_{0.55} hydride was obtained.

The Performance Test was Conducted Using the Same Method as Those Described in Examples 1 And 2.

I. The X-ray diffraction (XRD) spectrum at room temperature indicated that the hydride material had a NaZn₁₃-type structure.

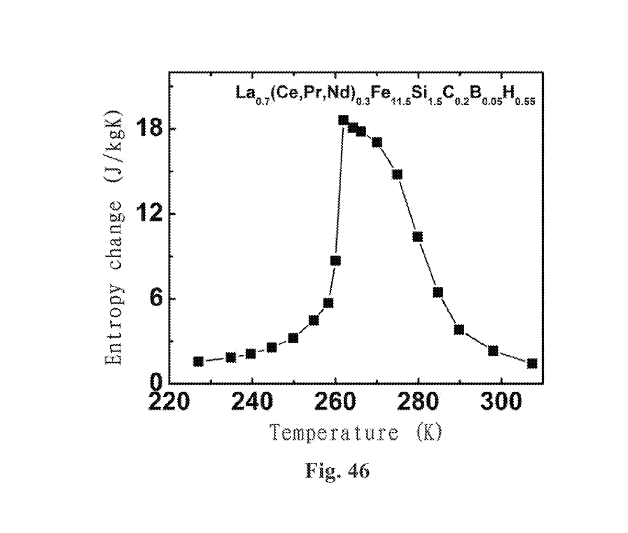

II. FIG. 45 and FIG. 46 show the thermomagnetic curves (M-T) in a magnetic field of 0.02 T and the dependency of the magnetic entropy change ΔS calculated according to Maxwell's equation on temperature (calculation of ΔS in the process of increasing the field). It was found that La_{0.7}(Ce,Pr,Nd)_{0.3}Fe_{11.5}Si_{1.5}C_{0.2}B_{0.05}H_{0.55} hydride material had a phase-transition temperature of ˜263K; maximal magnetic entropy change of about 19.0 J/kgK while the field was increased from 0 to 5 T and a considerable magnetocaloric effect.

Conclusion: The multiple interstitial carbon/boron/hydrogen compound obtained by annealing, in hydrogen atmosphere, the La(Fe,Si)₁₃-based carbon/boron compound prepared from industrial-pure La—Ce—Pr—Nd mischmetal as the raw material exhibited a considerable magnetocaloric effect. By regulating and controlling the hydrogen absorption process, the phase-transition temperature can be moved towards the higher temperature zone. As a result, the material has a great magnetic entropy change at a high temperature, which plays an important role in magnetic refrigerating application in practice.

### Comparative Example

### Rare Earth Metal Gd

Typical magnetic refrigeration material elementary rare earth Gd (with a purity of 99.9 wt. %) at room temperature was selected for the Comparative Example. Using MPMS (SQUID) VSM, it was measured that the Curie temperature was 293K; the magnetic entropy change at Curie temperature was 9.8 J/kgK while the field was increased from 0 to 5 T. It was found that the La(Fe,Si)₁₃-based magnetic refrigeration material prepared from industrial-pure La—Ce—Pr—Nd mischmetal or industrial-pure LaCe alloy as the raw material in most of the above Examples showed a magnetic entropy change significantly greater than that of Gd, meaning that these materials had greater magnetocaloric effect.

The invention has been described in detail by referring to the specific embodiments above. A person skilled in the field shall understand that the above specific embodiments should not be interpreted to restrict the scope of the invention. Therefore, without deviating from the spirit and extent of the invention, the embodiments of the invention can be altered and modified.

1. A La(Fe,Si)₁₃-based magnetic refrigeration material prepared from a raw material of an industrial-pure mischmetal, wherein the industrial-pure mischmetal is an impurity-containing and naturally proportionated La—Ce—Pr—Nd mischmetal or LaCe alloy which, as an intermediate product during rare earth extraction, is extracted from light rare earth ore, and the magnetic material has the NaZn₁₃-type structure, wherein
when the industrial-pure mischmetal is the impurity-containing La—Ce—Pr—Nd mischmetal extracted from light rare earth ore, the material is represented by the chemical formula: La₁₋ₓ(Ce,Pr,Nd)_{X}(Fe_{1-p-q}CoₚMn_{q})_{13-y}Si_{y}A_{α},
wherein, A is one or more selected from elements C, H and B,
x is in the range of 0<x≦0.5,
p is in the range of 0≦p≦0.2,
q is in the range of 0≦q≦0.2,
y is in the range of 0.8<y≦1.8,
α is in the range of 0≦α≦3.0,
wherein, the relative molar ratio of the three elements Ce, Pr and Nd is the same as the natural proportion of Ce, Pr and Nd in the La—Ce—Pr—Nd mischmetal, and the total number of moles of Ce, Pr and Nd is x; in the La—Ce—Pr—Nd mischmetal, the molar ratio of the four elements La, Ce, Pr and Nd is the same as their natural proportion in the light rare earth ore; the La—Ce—Pr—Nd mischmetal has a purity of ≧95 wt. %; the La—Ce—Pr—Nd mischmetal contains impurities comprising one or more of Sm, Fe, Si, Mg, Zn, W, Mo, Cu, Ni, Ti, Th, Y, Ca, Pb, Cr, C, H and O;
when the industrial-pure mischmetal is the impurity-containing LaCe alloy extracted from light rare earth ore, the material is represented by the chemical formula: La_{1-x-z}CeₓR_{Z}(Fe_{1-p-q}CoₚMn_{q})_{13-y}Si_{y}A_{α},
wherein, R is one or both selected from elements Pr and Nd,
A is one or more selected from elements C, H and B,
x is in the range of 0<x≦0.5,
z is in the range of 0≦z≦0.5, and x+z<1,
p is in the range of 0≦p≦0.2,
q is in the range of 0≦q≦0.2,
y is in the range of 0.8<y≦1.8,
α is in the range of 0≦α≦3.0,
wherein, the LaCe alloy has a purity of ≧95 at. %; and the atomic ratio of La:Ce in the alloy is the same as their natural proportion in the light rare earth ore; the LaCe alloy contains impurities comprising one or more of Pr, Nd, Sm, Fe, Si, Mg, Zn, W, Mo, Cu, Ni, Ti, Th, Y, Ca, Pb, Cr, C, H and O.

2. The magnetic refrigeration material according to claim 1, wherein, where the industrial-pure mischmetal is the impurity-containing La—Ce—Pr—Nd mischmetal, the magnetic refrigeration material further comprises one or more elements selected from Sm, Mg, Zn, W, Mo, Cu, Ti, Ca, Pb, Cr and O; and where A in the chemical formula does not include element C or H, the magnetic refrigeration material further comprises one or more elements selected from Sm, Mg, Zn, W, Mo, Cu, Ti, Ca, Pb, Cr, C, H and O.

3. The magnetic refrigeration material according to claim 1, wherein, where the industrial-pure mischmetal is the impurity-containing LaCe alloy, the magnetic refrigeration material further comprises one or more elements selected from Pr, Nd, Cu, Ni, Zn, Th, Y, Mg, Ca and O; an where the magnetic material is LaCeFeSi, the magnetic material further comprises one or more elements selected from Pr, Nd, C, H, Cu, Ni, Zn, Th, Y, Mg, Ca and O.

4. A method for preparing a magnetic refrigeration material according to claim 1, comprising the steps of:
1) preparing raw material according to the chemical formula, where A includes element H, the raw material other than H is prepared according to the chemical formula, the raw material comprises industrial-pure mischmetal, i.e., an impurity-containing and naturally proportionated La—Ce—Pr—Nd mischmetal or LaCe alloy which, as an intermediate product during rare earth extraction, is extracted from light rare earth ore; wherein, where the industrial-pure mischmetal is the impurity-containing La—Ce—Pr—Nd mischmetal extracted from light rare earth ore, the material is represented by the chemical formula: La₁₋ₓ(Ce,Pr,Nd)_{X}(Fe_{1-p-q}CoₚMn_{q})_{13-y}Si_{y}A_{α}, and where the industrial-pure mischmetal is the impurity-containing LaCe alloy extracted from light rare earth ore, the material is represented by the chemical formula: La_{1-x-z}CeₓR_{Z}(Fe_{1-p-q}CoₚMn_{q})_{13-y}Si_{y}A_{α};
2) preparing alloy ingots by arc melting technology, wherein the raw material prepared in step 1) is placed in an arc furnace, vacuumed, purged with argon gas, and smelted under the protection of argon gas so as to obtain the alloy ingots;
3) vacuum annealing the alloy ingots obtained in step 2) and then quenching the alloy ingots in liquid nitrogen or water so as to obtain the magnetocaloric material La_{1-x-z}CeₓR_{Z}(Fe_{1-p-q}CoₚMn_{q})_{13-y}Si_{y}A_{α} or La₁₋ₓ(Ce,Pr,Nd)_{X}(Fe_{1-p-q}CoₚMn_{q})_{13-y}Si_{y}A_{α} having a NaZn₁₃-type structure;
wherein, where A in the above chemical formula includes element H, the method further comprises the step of 4) pulverizing the material obtained from step 3) and then annealing the resultant powder in hydrogen gas.

5. The method according to claim 4, wherein, in the raw material La—Ce—Pr—Nd mischmetal, the molar ratio of the four elements La, Ce, Pr and Nd is the same as their natural proportion in the light rare earth ore; the La—Ce—Pr—Nd mischmetal has a purity of ≧95 wt. %, the La—Ce—Pr—Nd mischmetal contains impurities comprising one or more of Sm, Fe, Si, Mg, Zn, W, Mo, Cu, Ni, Ti, Th, Y, Ca, Pb, Cr, C, H and O.

6. The method according to claim 4, wherein, the raw material LaCe alloy has a purity of ≧95 at. %; and the atomic ratio of La:Ce in the alloy is the same as their natural proportion in the light rare earth ore; the LaCe alloy contains impurities comprising one or more of Pr, Nd, Sm, Fe, Si, Mg, Zn, W, Mo, Cu, Ni, Ti, Th, Y, Ca, Pb, Cr, C, H and O.

7. The method according to claim 4, wherein, in the raw material, where A includes element C, the element C is provided by FeC alloy; or where A includes element B, the element B is provided by FeB alloy.

8. The method according to claim 4, wherein, the step 2) comprises the steps of placing the raw material prepared in step 1) into an arc furnace; vacuuming the arc furnace to reach a vacuum degree of less than 1×10⁻² Pa; purging the furnace chamber once or twice with an argon gas having a purity of higher than 99 wt. %; then filling the furnace chamber with the argon gas to reach 0.5-1.5 atms; and arcing so as to obtain the alloy ingots; wherein each alloy ingot is smelted at 1500-2500° C. for 1-6 times repeatedly.

9. The method according to claim 4, wherein, the step 3) comprises the steps of annealing the smelted alloy ingots obtained from step 2) at 1000-1400° C. and under a vacuum degree of less than 1×10⁻³ Pa for from 1 hour to 60 days; then quenching the alloy ingots in liquid nitrogen or water so as to prepare the magnetic refrigeration material La_{1-x-z}CeₓR_{Z}(Fe_{1-p-q}CoₚMn_{q})_{13-y}Si_{y}A_{α} or La₁₋ₓ(Ce,Pr,Nd)_{X}(Fe_{1-p-q}CoₚMn_{q})_{13-y}Si_{y}A_{α} with a main phase being of NaZn₁₃-type structure.

10. The method according to claim 4, wherein, the step 4) comprises the steps of pulverizing the material prepared in step 3) into an irregular powder with a particle size of less than 2 mm; placing the powder in a hydrogen gas with a purity of higher than 99 wt. % and at a pressure of 0-100 atms; and annealing the resultant at 0-600° C. for from 1 minute to 10 days.

11. A magnetic refrigerator, comprising a magnetic refrigeration material according to claim 1.

12. Use of a magnetic refrigeration material according to claim 1.

13. The magnetic refrigeration material according to claim 1, wherein x is in the range of 0<x≦0.3.

14. The magnetic refrigeration material according to claim 1, wherein the La—Ce—Pr—Nd mischmetal has a purity of ≧98 wt. %.

15. The magnetic refrigeration material according to claim 1, wherein the atomic ratio of La:Ce in the alloy is 1:1.6-1:2.3.

16. The method according to claim 5, wherein the La—Ce—Pr—Nd mischmetal has a purity of ≧98 wt. %.

17. The method according to claim 4, wherein the La—Ce—Pr—Nd mischmetal has a purity of ≧98 wt. %.

18. The method according to claim 4, wherein the atomic ratio of La:Ce in the alloy is 1:1.6-1:2.3.

19. The method according to claim 8, wherein the smelting temperature is 1800-2500° C.

20. The method according to claim 10, wherein the hydrogen gas is at a pressure of 10⁻⁴-100 atms; and the annealing is at 100-350° C. for from 1 minute to 3 days.
